(19) United States
(12) Patent Application Publication
(10) Pub. No.: US 2026/0289097 A1
(43) Pub. Date: Sep. 24, 2026

(54) SYSTEM

(71) Applicant: SoftBank Group Corp., Tokyo (JP)

(72) Inventor: Risa SAKURABA, Tokyo (JP)

(73) Assignee: SoftBank Group Corp., Tokyo (JP)

(21) Appl. No.: 19/567,281

(22) Filed: Mar. 16, 2026

(30) Foreign Application Priority Data
Mar. 19, 2025 (JP) 2025-045123

(51) Int. Cl. G06F 40/174; G06F 18/22; G06F 40/186

(52) U.S. Cl. CPC G06F 40/174; G06F 18/22; G06F 40/186

(57) ABSTRACT

A system includes a processor that is configured to receive information from a user and store the information in a database, analyze the received information using a generative artificial intelligence model and extract important keywords from the received information, generate a first prompt based on the extracted keywords for selecting an optimal financial assistance program, and use a second prompt based on requirements of a selected financial assistance program to automatically generate an application document for the selected financial assistance program.

### CROSS-REFERENCE TO RELATED APPLICATION

This application is based on and claims priority under 35 USC 119 from Japanese Patent Application No. 2025-045123 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for preparing applications for financial assistance programs, such as subsidy programs and grant programs, require a user to manually identify applicable programs and to manually prepare application documents in accordance with the requirements of each program. In many cases, a user must search through multiple information sources, interpret complex eligibility conditions and document formats, and repeatedly revise the application text to satisfy formal and substantive requirements. This manual process is time-consuming, requires specialized knowledge, and easily leads to omissions, inconsistencies, or errors in the application documents. Furthermore, conventional systems do not sufficiently take into account the emotional state of the user, and therefore fail to provide adaptive support that reduces user stress and improves the quality and persuasiveness of the application text. In addition, in many existing tools, even when some form of automation is provided, the logic for using a generative artificial intelligence model is not clearly structured, so that prompts for selecting an optimal financial assistance program and prompts for generating compliant application documents are not systematically generated and managed. Accordingly, there is a need for a system that can: efficiently receive and store user information, automatically analyze the information using a generative artificial intelligence model, select an optimal financial assistance program based on extracted keywords, and automatically generate application documents that are adjustable in accordance with the user's emotional state and easily reviewable and modifiable through a user interface.

### SUMMARY

In order to solve at least part of the above-described problems, an aspect of the present invention provides a system comprising a processor, wherein the processor is configured to receive information from a user and store the information in a database, analyze the received information using a generative artificial intelligence model and extract important keywords from the received information, generate a first prompt based on the extracted keywords for selecting an optimal financial assistance program, and use a second prompt based on requirements of a selected financial assistance program to automatically generate an application document for the selected financial assistance program. In some embodiments, the processor is further configured to analyze an emotional state of the user and generate a third prompt for adjusting the application document in accordance with the emotional state of the user, thereby enabling the system to adapt tone, level of detail, or explanatory content of the application document to the user's emotional condition and reduce user burden during preparation. In additional embodiments, the processor is configured to display the generated application document via a user interface and enable the user to confirm and modify the generated application document, so that the user can easily review, correct, and supplement auto-generated content before final submission. By systematically combining database storage of user information, generative artificial intelligence based analysis and prompt generation, emotional-state-aware adjustment, and interactive user interface based confirmation and modification, the system according to the present invention can significantly streamline the selection of financial assistance programs and the preparation of high-quality application documents.
The term “system” refers to an aggregation of hardware and software components, including at least one processor and associated memory and interfaces, that cooperate to perform the processing described in the claims.
The term “processor” refers to one or more hardware processing units, such as a central processing unit (CPU), a graphics processing unit (GPU), a microcontroller, or any combination thereof, configured to execute instructions and thereby implement the functions recited in the claims.
The term “user” refers to a human operator or an entity acting through a human operator that interacts with the system, for example by providing information, reviewing generated documents, and issuing commands via a user interface.
The term “database” refers to any structured data storage system, including relational databases, NoSQL databases, key-value stores, or equivalent data repositories, that stores information received from the user and information generated by the processor so that such information can be retrieved and processed.
The term “generative artificial intelligence model” refers to a machine learning model configured to generate content, such as text or intermediate representations, based on input data, including but not limited to large language models, generative adversarial networks, transformer-based models, or other generative architectures.
The term “information” refers to data provided by the user, including but not limited to project descriptions, organizational details, requirements, preferences, or any other textual or structured data relevant to selection of a financial assistance program and preparation of an application document.
The term “analyze” refers to processing input information by applying one or more computational techniques, such as natural language processing, pattern recognition, classification, or semantic parsing, to derive structured representations, features, or interpretations from the information.
The term “keywords” refers to words, phrases, or tokens extracted from the information that are determined to be important for characterizing the content or context of the information, such as indicators of project type, technical field, purpose, or eligibility conditions.
The term “financial assistance program” refers to any program, scheme, grant, subsidy, funding opportunity, or similar initiative that provides monetary or equivalent support to eligible applicants based on predefined requirements.
The term “optimal financial assistance program” refers to a financial assistance program that is determined, according to one or more criteria or algorithms implemented by the processor, to be most suitable among multiple available financial assistance programs for the information received from the user.
The term “prompt” refers to data provided as input to the generative artificial intelligence model, including instructions, conditions, context, or constraints, that guide the model in generating a desired output, such as a program selection result or a draft application document.
The term “first prompt” refers to a prompt generated based on the extracted keywords and configured to cause the generative artificial intelligence model or another selection process to identify or assist in identifying an optimal financial assistance program.
The term “second prompt” refers to a prompt generated based on requirements of a selected financial assistance program and configured to cause the generative artificial intelligence model to automatically generate at least a portion of an application document corresponding to the selected financial assistance program.
The term “application document” refers to any document, set of documents, or structured electronic data required to apply for a financial assistance program, including forms, narratives, budgets, plans, and other information to be submitted to an administering authority.
The term “emotional state” refers to a psychological or affective condition of the user, such as stress level, confidence, frustration, or enthusiasm, inferred from user inputs, interaction patterns, biometric data, or other indicators.
The term “third prompt” refers to a prompt generated based on the emotional state of the user and configured to cause the generative artificial intelligence model to adjust the content, tone, level of detail, or structure of the application document in accordance with the emotional state.
The term “user interface” refers to any interface through which the user interacts with the system, including graphical user interfaces, web interfaces, mobile application interfaces, command-line interfaces, or voice-based interfaces.
The term “display” refers to presenting information from the system to the user via the user interface, including rendering text, graphics, or interactive elements on a screen or providing equivalent output through another presentation medium.
The term “modify” refers to performing one or more changes to the content of the generated application document, including editing text, adding new information, deleting information, or rearranging sections, by actions initiated by the user through the user interface.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

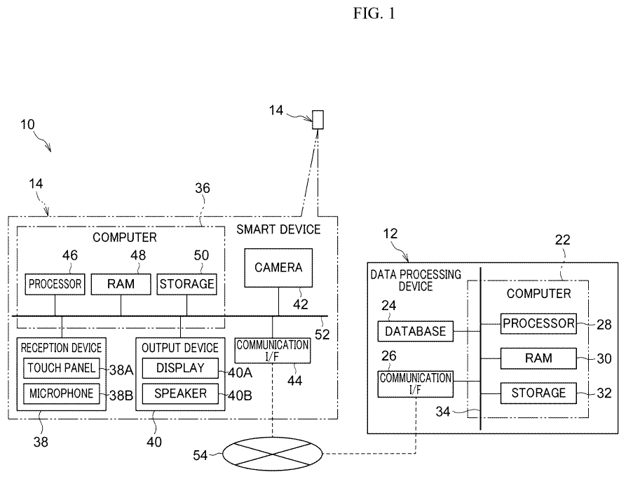

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

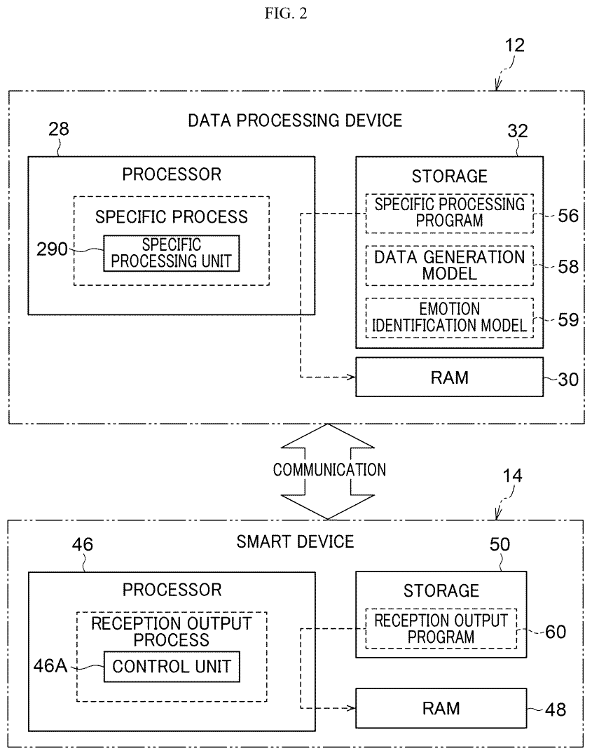

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented systems for preparing funding application documents generally rely on static forms, rule-based matching engines, and manually defined templates. In such systems, a processor typically receives user-entered text, stores it in a database, and applies simple keyword matching or fixed conditional logic to select a funding scheme and populate a document template. This approach suffers from several technical limitations in terms of data processing efficiency, adaptability, and accuracy.
First, conventional systems do not effectively transform unstructured natural language input into rich structured representations suitable for complex database querying. As a result, a processor must either apply computationally expensive generic search operations or rely on brittle, hand-crafted rules that do not scale well to diverse project descriptions and funding conditions. This leads to inefficient utilization of storage and processing resources, increased latency in scheme selection, and a higher probability of returning suboptimal or irrelevant funding schemes.
Second, existing systems lack a dynamically configurable interface between natural language processing components and downstream document generation components. In many implementations, natural language analysis, scheme selection, and document generation are tightly coupled and hard-coded. This tight coupling prevents flexible adaptation of the analysis logic, and it limits the ability of the processor to reuse analysis results for multiple tasks such as scheme selection, document creation, and consistency checking. Consequently, modifications to one part of the pipeline require wide-ranging code changes and often involve redundant computations.
Third, in conventional document preparation workflows, content refinement and validation typically depend on manual review or fixed validation rules. Such mechanisms cannot effectively capture nuanced deficiencies in narrative sections of application documents, such as missing justification of project impact, unclear objectives, or inconsistent descriptions across sections. Additionally, conventional systems do not exploit advanced generative models to assist in iterative completion, formatting, and quality control of the application text, which results in increased user burden, higher error rates, and difficulty in generating documents that comply fully with complex funding requirements.
Fourth, user interaction in conventional systems is not adaptively tailored based on the user's state or the evolving content of the application. Processors do not leverage contextual signals, such as the semantic structure of the text or inferred emotional state of the user, to adjust the granularity or style of system-generated explanations and suggestions. This can cause cognitive overload for inexperienced users, suboptimal guidance, and inefficient navigation through multi-step application processes.

Accordingly, there is a need for an improved computer-implemented system in which a processor cooperates with a generative AI model through explicitly constructed prompt sentences, so as to (i) convert unstructured user input into structured data optimized for scheme selection, (ii) orchestrate scheme selection and document generation using that structured data, and (iii) iteratively complement, format, and validate the resulting documents. By re-architecting the interaction between the processor, the generative AI model, and storage resources, it is desirable to improve accuracy and efficiency of funding scheme selection and application document generation, while reducing computational redundancy and user burden.

The specific processing by the specific processing unit 290 of the data processing device 12 in Example 1 is realized by the following means.

The present invention provides a server comprising a processor configured to receive character information including activity content from a user terminal and store the character information in a storage device; generate a first prompt sentence that instructs a generative AI model to perform analysis processing using the character information and attribute information related to the activity content as input, and to obtain from the generative AI model an analysis result from which the processor extracts structured information related to the activity content and feature information used for selection of a financial assistance scheme; execute, using the structured information and the feature information, a search process on a data storage device in which financial assistance scheme information is stored, extract a plurality of financial assistance scheme candidates suitable for the activity content, calculate a suitability degree for each of the candidates, and select an optimal financial assistance scheme; determine a correspondence relationship between placeholders corresponding to respective items of an application document and the structured information, based on document format information associated with the selected financial assistance scheme and the structured information, and generate application document data by automatically filling the placeholders according to the correspondence relationship; generate a second prompt sentence for using the generative AI model for creation, correction, or summarization of the application document data, and input the second prompt sentence and the application document data to the generative AI model to complement or format content of the application document data; convert the complemented or formatted application document data into a display data format and transmit the display data format to the user terminal via a communication unit; receive, from the user terminal, correction content for the application document data, reflect the correction content in the application document data to generate final application document data, and transmit the final application document data to an external application reception apparatus; generate a third prompt sentence for inputting information related to a user emotion or operation history information on the user terminal to the generative AI model and, based on an analysis result related to an emotional state acquired from the generative AI model, adjust expression content or explanation content included in the application document data to a writing style or a level of detail corresponding to the emotional state; and generate a fourth prompt sentence for causing the generative AI model to verify presence or absence of mandatory description items with respect to a creation process of the application document data or the final application document data, extract missing items or unclear items based on a verification result acquired from the generative AI model, and present the missing items or the unclear items on a user interface to prompt additional input. This enables the processor to reorganize unstructured natural language input into a structured representation suitable for optimized search and document assembly, to coordinate multiple generative AI model calls through explicit prompt sentences for analysis, refinement, and validation, and thereby to improve computational efficiency, accuracy, and robustness of funding scheme selection and application document generation in comparison with conventional rule-based or manually configured systems.
The term “processor” refers to a hardware or virtual computing element, such as a central processing unit, a graphics processing unit, a microcontroller, or an execution core of a virtual machine, that executes machine-readable instructions to perform data processing operations described in the present specification.
The term “user terminal” refers to an electronic apparatus, such as a smartphone, a tablet device, a notebook computer, a desktop computer, or any network-capable client device, that includes an input unit and a display unit and that communicates with a server via a communication network.
The term “character information” refers to digital data representing text composed of characters, symbols, or numerals, including natural language sentences describing activity content, which is received from a user terminal and processed by the processor.
The term “activity content” refers to information describing a planned or ongoing project, undertaking, or operation, including at least a purpose, an outline, or conditions of the project, which serves as a basis for selection of a financial assistance scheme and generation of an application document.
The term “attribute information related to the activity content” refers to metadata associated with the activity content, including, for example, a project type, a field or sector, a geographic region, an organization type, a budget scale, or a schedule, which may be explicitly input by a user or inferred by a processing operation.
The term “storage device” refers to a hardware or virtual storage resource, such as a semiconductor memory, a magnetic storage medium, an optical storage medium, or a network-based storage service, that stores character information, structured information, financial assistance scheme information, document format information, and application document data.
The term “data storage device” refers to a storage device or a logically distinct storage region that stores structured data sets, including at least financial assistance scheme information and associated document format information, which can be retrieved by search processing.
The term “financial assistance scheme information” refers to structured data representing conditions, eligibility criteria, funding limits, target domains, and other attributes of one or more financial support programs, subsidy programs, grant programs, or similar funding mechanisms.
The term “financial assistance scheme candidate” refers to a particular financial assistance scheme selected as a potential match for given activity content based on structured information and feature information, prior to calculation of a suitability degree.
The term “optimal financial assistance scheme” refers to one financial assistance scheme, or a subset of financial assistance schemes, that is selected from among multiple financial assistance scheme candidates based on a suitability degree or similar evaluation metric.
The term “generative AI model” refers to a machine learning model that has been trained using example data to generate or transform natural language, structured text, or other data, and that is capable of performing tasks such as analysis, summarization, completion, or rephrasing in response to input data and a prompt sentence.
The term “prompt sentence” refers to a text or structured instruction sequence provided as input to a generative AI model, the prompt sentence specifying at least a processing task to be performed by the generative AI model and possibly including contextual information, constraints, or output formatting instructions.
The term “analysis processing” refers to processing performed by a generative AI model or by the processor to interpret input data, including one or more of natural language understanding, extraction of key phrases, classification, or inference of attributes from character information and attribute information related to the activity content.
The term “analysis result” refers to output data generated by a generative AI model in response to an analysis-related prompt sentence, the output data including, for example, extracted attributes, structured representations, or other information derived from input text.
The term “structured information” refers to data that has been organized into a predefined format or schema, such as key-value pairs, records, or tables, including fields corresponding to project attributes, eligibility attributes, and other elements that can be used for search and document generation.
The term “feature information” refers to selected elements of structured information or derived attributes that are used as criteria for searching financial assistance scheme information, such as sector classification, region, beneficiary type, or budget requirements.
The term “suitability degree” refers to a numerical score or qualitative ranking value that indicates the level of correspondence between a given financial assistance scheme candidate and the activity content, as calculated by a processor based on structured information and feature information.
The term “document format information” refers to template-related data, including layout definitions, item lists, field names, and placeholder specifications, that define a format of an application document required by a financial assistance scheme.
The term “placeholder” refers to a symbolic token or marker contained in document format information or a template file, which is associated with a particular data item and is replaced with corresponding structured information during generation of application document data.
The term “correspondence relationship” refers to an association mapping between placeholders included in document format information and specific elements of structured information, the association enabling automatic substitution of placeholders with actual values.
The term “application document” refers to a document required for applying to a financial assistance scheme, including, for example, sections describing project objectives, methods, schedules, budgets, and expected outcomes, and which may be represented in one or more digital formats.
The term “application document data” refers to digital data that represents the content and structure of an application document, including text, identifiers, layout information, and associated metadata, which can be stored, edited, transmitted, and rendered by a computing apparatus.
The term “creation of the application document data” refers to generation of initial or intermediate versions of application document data from character information, structured information, feature information, and document format information by using program-controlled operations and, optionally, a generative AI model.
The term “correction of the application document data” refers to modification of existing application document data based on user-provided edits, automatic suggestions, or generative AI model outputs, such that portions of the content are updated or refined.
The term “summarization of the application document data” refers to processing that generates a condensed representation of part or all of the application document data, including shortened descriptions or abstracted explanations, using the generative AI model or other algorithms.
The term “complement content of the application document data” refers to the act of adding missing information, expanding insufficient explanations, or inserting new sentences or sections into the application document data based on outputs from the generative AI model.
The term “format content of the application document data” refers to the act of adjusting structure, layout, style, or linguistic register of text within the application document data to conform to a desired format, template, or writing style, based on a generative AI model or deterministic rules.
The term “display data format” refers to a format suitable for visual presentation on a user terminal, such as a markup language, a rendered image, or a document viewer format, which is derived from the application document data.
The term “communication unit” refers to a hardware or software component, such as a network interface controller, a modem, or a communication driver, that enables data transmission and reception between the server and external devices via a communication network.
The term “correction content” refers to modification information, including text changes, additions, deletions, or formatting instructions, that is input by a user via a user terminal with respect to previously presented application document data.
The term “final application document data” refers to application document data that has incorporated correction content and has completed all prescribed refinement and validation processes, and that is ready to be transmitted to an external application reception apparatus.
The term “external application reception apparatus” refers to a computing system or device managed by an entity that receives funding applications, such as a public institution or a private organization, and that is configured to accept, store, and process final application document data.
The term “information related to a user emotion” refers to data indicative of an emotional state of a user, including, for example, explicit user feedback, sentiment-expressing text, or other signals that can be interpreted by a generative AI model as reflecting user emotion.
The term “operation history information” refers to data representing one or more user interactions with a user interface, such as input sequences, navigation paths, editing patterns, time spent on fields, or response times, which can be used to infer user state or context.
The term “emotional state” refers to a condition inferred for a user, such as a level of confidence, confusion, urgency, or frustration, which is estimated based on information related to a user emotion or operation history information using analysis processing.
The term “expression content” refers to textual portions of application document data, including sentences or paragraphs, whose wording, tone, or style may be adjusted depending on user emotion or other contextual factors.
The term “explanation content” refers to textual descriptions, guidance, or commentary generated for a user, including explanations of funding schemes, instructions for filling in fields, or rationales for selected schemes, which may be adapted in style or detail.
The term “writing style” refers to characteristics of textual expression, including formality level, politeness level, sentence complexity, and terminology usage, which can be modified to better match a user's emotional state or expertise level.
The term “level of detail” refers to a degree of granularity of information included in explanation content or application document content, such as the number of steps described, the depth of explanation, or the amount of contextual background provided.
The term “mandatory description item” refers to an element of information that is required to be present in an application document in order to comply with rules or guidelines of a financial assistance scheme, such as a project objective, a schedule, a budget breakdown, or an expected effect.
The term “verification of presence or absence of mandatory description items” refers to checking whether each required item is explicitly or implicitly included in the application document data or final application document data, using outputs from a generative AI model or other analysis.
The term “missing item” refers to a mandatory description item that is not sufficiently present or is entirely absent in the application document data, as determined by a verification process.
The term “unclear item” refers to a description that is present in the application document data but is deemed ambiguous, incomplete, or insufficiently detailed relative to a mandatory description item.
The term “user interface” refers to a software-controlled presentation and input environment, such as a graphical user interface, a web interface, or a mobile application interface, through which a user can view information and input or modify data.

In one embodiment, a server cooperates with one or more user terminals to implement the claimed system. The server includes at least one processor, a main memory, a non-volatile storage device, and a communication interface connected to a packet-switched network. The server executes an operating system such as a general-purpose server operating system and a web application framework such as an HTTP server and an application server. The server further executes a database management system, such as a relational database engine, and communicates with an external generative AI model that is deployed as a network-accessible inference service. The user terminal includes at least a display device, an input device such as a keyboard or touch panel, and a communication module, and runs a web browser or a native application.

The server stores, in the non-volatile storage device, program modules including a user interface management module, an input parsing module, an AI orchestration module, a scheme selection module, a document generation module, an emotion analysis module, a completeness verification module, and a data persistence module. The server loads these program modules into memory and the processor executes them to perform the functions described below.

The server receives character information including activity content from a user terminal. The terminal sends the character information using an HTTPS request from a browser engine such as a layout and JavaScript engine. The character information is represented as Unicode text strings and is encapsulated in a structured message such as a JSON object. The server parses the JSON object, normalizes character encoding, and stores the raw text and associated metadata in tables of the relational database. The database schema defines at least a project table, a user table, a scheme table, and a document table, each having primary keys and indexed foreign keys to support efficient joins and search operations.

The server generates a first prompt sentence for a generative AI model by combining a system-level instruction, task-specific instructions, and the user-provided character information. In one example, the server constructs a prompt sentence such as:
“You are an assistant that extracts funding-related attributes from project descriptions.

Analyze the following project description and extract the attributes needed to select optimal financial assistance schemes.
Project description: ‘We plan to organize an event that utilizes regional tourism resources, such as local festivals and historical landmarks, to attract more visitors.’

Output a structured description of the project including project type, industry sector, target region (if mentioned), target beneficiaries, approximate budget (if mentioned), and key objectives.”

The server then sends this prompt sentence to a generative AI model through an API client. The generative AI model is implemented as a transformer-based neural network comprising multiple encoder and decoder layers, multi-head self-attention mechanisms, and feed-forward sublayers. The model receives tokenized input sequences and generates token sequences corresponding to the requested structured information. The model is pre-trained on large-scale text corpora using a language modeling objective and optionally fine-tuned on domain-specific funding application data. During fine-tuning, the model parameters (weights and biases of linear projection layers and attention layers) are updated by stochastic gradient descent or an adaptive optimizer, using a loss function such as cross-entropy over target token sequences. Training data may be augmented by paraphrasing, synonym substitution, and template-based generation to improve robustness to variation in user input.

The server uses a tokenizer associated with the generative AI model to convert the prompt sentence and the user's text into token IDs. The server specifies configuration parameters such as maximum token length, sampling temperature, and top-k or top-p sampling thresholds when calling the inference API. The server receives generated output text from the model and parses the output to obtain structured information. In one configuration, the server instructs the model to output a delimited format, and the server converts the delimited segments into a structured record with explicit fields. The server validates each field using schema constraints stored in the database, for example verifying that a region matches known region codes and that a budget field can be parsed as a numeric value. Through this process, the server converts unstructured natural language into structured information optimized for indexing and query execution.

The server generates feature information from the structured information by applying additional logic. For example, the server maps free-text industry descriptions into a normalized industry taxonomy using lookup tables or vector similarity measures. The server may use low-dimensional vector embeddings produced by an auxiliary neural network, such as a sentence encoder, to measure similarity between project descriptions and predefined domain labels. By storing these feature vectors in the database, the server enables efficient nearest-neighbor queries using specialized index structures. This mapping improves retrieval accuracy while reducing computational cost during scheme selection.

The server performs search processing in the data storage device by constructing parameterized queries using the structured information and feature information. The server uses the relational database engine to filter financial assistance schemes based on constraints such as minimum and maximum budget, eligible industry sectors, eligible regions, and applicant types. The server further computes a suitability degree for each candidate scheme using a scoring function that may combine rule-based conditions and similarity scores derived from vector embeddings. The server can implement the scoring function as an SQL expression or as an in-memory computation. This design ensures that the search space is narrowed by index-based filtering before any more expensive similarity calculations are applied, thus improving processing speed.

The server selects one or more optimal financial assistance schemes by ranking candidates according to the suitability degree. The server may also use a secondary generative AI model call to generate an explanatory text for each scheme, specifying why the scheme matches the activity content, but the selection process itself is carried out deterministically by the scheme selection module using the structured information and pre-defined scoring criteria. This separation of deterministic selection logic from natural language explanation improves predictability and repeatability of the selection results.

The server stores document format information for each financial assistance scheme in the database or in template files on the storage device. The document format information defines placeholders corresponding to specific data elements, such as project title, applicant name, project objectives, implementation schedule, and budget breakdown. The server generates a correspondence relationship between these placeholders and specific fields in the structured information and feature information. In one embodiment, the server maintains a mapping table in the database linking placeholder identifiers to schema field names and specifying transformation rules, such as date formatting or numeric formatting. When generating application document data, the server retrieves the relevant mapping table entries and applies the transformation rules to fill each placeholder. The server uses a template processing engine, such as a text-based template engine or a document generation library, to perform the placeholder substitution and produce application document data in a machine-readable format.

The server generates a second prompt sentence for using the generative AI model to create, correct, or summarize parts of the application document data. In one example, the server constructs a prompt sentence such as:
“You are an assistant that reformulates and completes funding application text.

Based on the following structured project information, generate a coherent project summary suitable for a funding application, including objectives, methods, and expected outcomes.
Structured information: [project attributes listed in text form].”

In another example, the server constructs a prompt sentence such as:
“You are an assistant that improves clarity and style of funding applications.

Rewrite the following project description in a formal and concise style suitable for a government funding application, without changing the technical content.
Text: [current project description].”

The server passes the relevant portions of the application document data to the generative AI model along with this second prompt sentence. The generative AI model then generates revised or extended text segments. The server integrates these text segments back into the application document data at positions determined by the template engine and mapping table. The server may maintain a version history of generated text segments in the database to support comparison, rollback, and quality control.

The server converts the complemented or formatted application document data into a display data format suitable for a user terminal. For a web terminal, the server may render the document as HTML with cascading style sheets, or may generate a PDF representation using a rendering engine controlled by the server. The server sends the resulting display data to the user terminal via the communication interface. The terminal receives the display data and displays it on the screen. The user reviews the content and inputs corrections or additional information using input elements provided by the user interface. The terminal then sends correction content back to the server in a structured form, where the server merges the corrections into the application document data and updates the stored representation.

The server generates a third prompt sentence for inputting information related to a user emotion or operation history information into the generative AI model. The server may aggregate interaction metrics such as time spent on each form section, frequency of corrections, or repeated requests for help. The server converts these metrics into a descriptive text such as:
“The user has repeatedly edited the budget section and has spent a long time on this section. Please infer whether the user appears confused or uncertain based on this behavior.”

The server may also analyze sentiment in the user's free-text comments using an auxiliary classifier. The generative AI model returns an inferred emotional state or a categorized user state. The server uses this information to adjust expression content or explanation content included in the application document data or in the on-screen guidance. For example, if the user is inferred to be confused, the server generates longer, more detailed explanations and uses a more supportive writing style in explanatory messages. If the user is inferred to be experienced, the server reduces the verbosity and presents more concise technical summaries. This adaptive adjustment is implemented by dynamically changing the prompt sentence used for explanation generation and by selecting different explanation templates in the server.

The server generates a fourth prompt sentence for causing the generative AI model to verify presence or absence of mandatory description items. For example, the server constructs a prompt sentence such as:
“You are an assistant that checks completeness of funding applications.

Check whether the following application text explicitly covers the mandatory items: project objectives, implementation methods, schedule, budget breakdown, and expected effects.

For each item, indicate whether it is sufficiently described, missing, or unclear, and briefly explain your reasoning.

Application text: [combined text from the application document].”

The server receives the output and parses it to determine which items are missing or unclear. The server then marks corresponding sections in the application document data and generates user interface prompts highlighting the missing or unclear items. The server can use this information to guide the user through additional input steps, thereby improving completeness and reducing the likelihood of rejection by the external application reception apparatus.

From a technical perspective, this architecture improves computer technology beyond mere automation of human work. The server performs a specific transformation of data: unstructured, user-entered natural language is converted into structured representations optimized for indexed database search and template-based document assembly. By enforcing schema validation and mapping placeholder identifiers to structured information fields, the server reduces redundancy and ensures consistent use of project attributes across multiple documents, which improves data integrity and resource efficiency in storage and processing.

The server reduces processing time and network load by separating deterministic selection and validation logic from natural language generation. The server uses indexes and precomputed feature mappings to limit the number of financial assistance scheme candidates, thereby decreasing the number of expensive generative AI model calls. This design directly improves throughput and reduces latency in multi-user environments. The server can batch certain generative AI model calls for multiple user requests, leveraging mini-batch inference of the transformer network to further improve computational efficiency on the AI backend.

The generative AI model is used not merely as a generic text processor, but in conjunction with explicit prompt sentences and structured post-processing algorithms. The server imposes non-conventional control flows: it constrains the model output to specific fields, validates each field against database constraints, and uses structured output as a basis for downstream ranking and completeness checking algorithms. The combination of transformer-based inference, schema-aware parsing, and attribute-based scoring constitutes a technical solution that allows the server to achieve higher accuracy in scheme selection and document completeness than rule-based systems, while controlling computational cost.

In another embodiment, the server hosts the generative AI model locally, executed on an accelerator such as a graphics processing device or a tensor processing device. The model weights are stored in the storage device and loaded into device memory. The server implements a model runtime that performs forward passes of the transformer network using optimized linear algebra libraries. The server applies quantization and model compression techniques to reduce memory usage, and uses caching of intermediate key-value pairs for repeated inference on related prompts. These techniques enable the server to serve multiple concurrent requests with lower hardware resource consumption, representing a technical improvement in model serving infrastructure.

In further embodiments, the server includes different neural network architectures, such as an encoder-only model for attribute extraction and an encoder-decoder model for document generation. The server selects an appropriate model depending on the type of prompt sentence and the length of input text. The server may also employ a multi-stage pipeline in which an initial classifier model routes requests to specialized models tuned for certain industries or document types. This modular architecture reduces the number of parameters required for each specialized task and increases accuracy by utilizing domain-specific model variants.

The server achieves reduced communication load by transmitting structured information and compact references rather than entire raw documents wherever possible. For example, when the user requests a summary of changes, the server transmits only a concise diff representation or a short summary generated by the model, instead of sending full document content. The server also uses short prompt sentences that reference stored structured information by identifier, thereby avoiding repeated transmission of the same data to the generative AI model. This design lowers bandwidth usage between components and shortens processing time.

In a variant embodiment, the server is integrated with a document signing device or a workflow management system. Once the final application document data is generated, the server can automatically format it for electronic signatures or embed metadata recognizable by downstream processing systems. This integration allows the same structured information and mapping logic to be reused for additional technical tasks such as secure document routing, metadata-based indexing, and automated archival.

The user uses the user terminal to interact with the system at various stages. The user initially inputs activity content as free text, reviews automatically generated scheme selection results and documents, and provides corrections or additions. The terminal handles rendering operations and user input capture, but the technical transformation of data, the orchestration of generative AI model calls, the structured mapping to document templates, and the adaptive guidance based on completeness and emotional state are executed by the server. This separation ensures that the heavy computational tasks and optimization of data structures and processing sequences are performed where the server can apply database indexing, hardware acceleration, and algorithmic control.

Through these embodiments, the system realizes a concrete improvement in the way computers store, retrieve, and transform unstructured funding-related information, achieving enhanced accuracy, processing speed, and robustness over conventional, rule-based or purely manual systems.

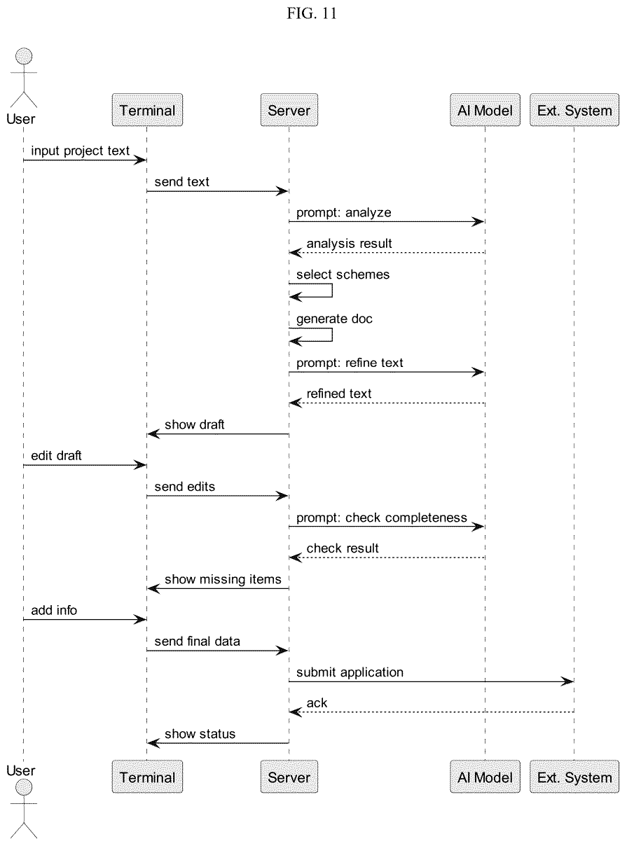

The following describes the processing flow using FIG. 11.

### Step 1:

The user operates the terminal and inputs activity content as character information. The user types a project description and, optionally, attribute information such as industry, region, and budget into input fields displayed by a browser or native application. The terminal converts keystrokes or touch input into text strings using an operating system input framework and stores the text in memory variables. The terminal generates a structured message including fields such as project_description, optional_attributes, and user_id.
Input: raw user keystrokes and touch operations.
Output: structured character information and attribute information held in the terminal's memory.

### Step 2:

The terminal sends the structured character information and attribute information to the server. The terminal serializes the information into a message format such as JSON, encapsulates it in an HTTPS POST request, and transmits it via a communication module over a network.
Input: structured character information and attribute information.
Output: a network request containing the user data, delivered to the server.

### Step 3:

The server receives the network request and parses the user data. The server uses an HTTP server module to accept the request, a JSON parser to decode the message, and a validation routine to check for required fields and valid encoding. The server then writes the validated project description and attribute information into tables of a database, associating them with a project identifier and a user identifier.
Input: serialized user data from the terminal.
Output: stored records in the database representing the project and associated attributes.

### Step 4:

The server generates a first prompt sentence for a generative AI model to perform analysis processing. The server concatenates a system instruction, a task description, and the stored project description and attribute information into a single prompt string. The server may normalize whitespace, escape special characters, and insert markers indicating required output fields.
Input: project description text and attribute information from the database.
Output: a first prompt sentence formatted for submission to the generative AI model.

### Step 5:

The server sends the first prompt sentence to the generative AI model and obtains an analysis result. The server calls an AI inference API, tokenizes the prompt sentence, sets parameters such as maximum token length and temperature, and transmits the token sequence to the generative AI model. The generative AI model executes a transformer-based forward pass, applying attention and feed-forward operations to generate output tokens. The server receives the generated output text and aggregates tokens into a response string.
Input: first prompt sentence.
Output: analysis result text containing structured project attributes and feature information in a machine-readable format.

### Step 6:

The server converts the analysis result text into structured information and feature information. The server parses the text according to delimiters or pseudo-structured patterns specified in the prompt, extracting fields such as project_type, industry_sector, target_region, target_beneficiaries, and approximate_budget. The server converts numeric strings into numeric values, maps free-text categories to controlled vocabularies using lookup tables, and stores the resulting structured records in database tables.
Input: analysis result text from the generative AI model.
Output: structured information and feature information stored as database records or in-memory objects.

### Step 7:

The server searches a data storage device containing financial assistance scheme information using the structured information and feature information. The server constructs database queries that filter schemes by region, industry sector, applicant type, and budget range. The server uses indexed columns and, if available, vector similarity indexes for feature vectors to efficiently retrieve candidate schemes. The server computes a suitability score for each candidate using a scoring function that aggregates matches over multiple fields.
Input: structured information and feature information; financial assistance scheme records in the database.
Output: a ranked list of financial assistance scheme candidates with associated suitability scores.

### Step 8:

The server selects one or more optimal financial assistance schemes from the ranked list. The server sorts candidates by suitability score, applies tie-breaking rules if necessary, and chooses the top candidate or a subset of top candidates based on configurable thresholds. The server updates the project record to associate it with selected scheme identifiers.
Input: ranked list of scheme candidates with scores.
Output: selected optimal financial assistance scheme identifiers linked to the project.

### Step 9:

The server retrieves document format information corresponding to each selected financial assistance scheme. The server queries a template table or reads template files from storage, obtaining placeholder definitions and layout metadata. The server builds a mapping (correspondence relationship) between placeholders and fields in the structured information and feature information by consulting a placeholder-to-field mapping table.
Input: selected scheme identifiers and structured information.
Output: a mapping configuration that associates each placeholder with specific project attribute fields.

### Step 10:

The server generates application document data by filling placeholders according to the correspondence relationship. The server invokes a template engine, passing in the mapping configuration and the structured information. The template engine replaces each placeholder with the corresponding field value, applies formatting rules (such as date and currency formatting), and produces a complete document representation in an internal data structure. The server stores the generated application document data in the database or file storage.
Input: template with placeholders and placeholder-to-field mapping; structured information.
Output: initial application document data in a machine-readable format.

### Step 11:

The server generates a second prompt sentence to use the generative AI model for creation, correction, or summarization of portions of the application document data. The server identifies document sections requiring narrative text, such as project summary or expected outcomes, and constructs a prompt that includes structured attributes and current draft text. The server formats the prompt with clear instructions and boundary markers around the text segments to be refined or generated.
Input: application document data and structured information.
Output: a second prompt sentence tailored for document text generation or refinement.

### Step 12:

The server sends the second prompt sentence and relevant document segments to the generative AI model and receives revised or supplemental text. The server calls the AI inference API, transmits the prompt, and configures output length constraints. The generative AI model generates improved narrative sections by applying its learned language model and attention mechanisms to the input. The server collects the generated text and separates it into segments matching the requested sections.
Input: second prompt sentence and selected document segments.
Output: generated or revised text segments for insertion into the application document data.

### Step 13:

The server integrates the generated or revised text segments into the application document data. The server replaces or inserts text at positions indicated by internal markers, updates the version number of the document, and stores the updated content back into storage. The server may log both original and revised segments for audit and rollback purposes.
Input: existing application document data and generated text segments.
Output: complemented or formatted application document data ready for user review.

### Step 14:

The server converts the complemented or formatted application document data into a display data format and sends it to the terminal. The server renders the document as HTML, PDF, or another displayable format, attaches styling information, and encapsulates the display data in an HTTP response. The terminal receives the response, decodes the display data, and uses a browser engine or document viewer to present the document on the screen.
Input: complemented or formatted application document data.
Output: display data transmitted to the terminal and rendered as a viewable document.

### Step 15:

The user reviews the displayed application document on the terminal and inputs correction content. The user examines sections such as objectives, schedule, and budget, and edits text or fills in missing fields using form controls. The terminal tracks the changed fields, collects the new content into an update object, and prepares the correction content for transmission.
Input: displayed application document and user interactions.
Output: correction content held in the terminal as updated field values.

### Step 16:

The terminal sends the correction content to the server. The terminal serializes the updated field values into a structured message, such as a JSON object containing document identifiers and changed sections, and transmits this message via HTTPS to a correction endpoint on the server.
Input: correction content from user edits.
Output: a correction request message delivered to the server.

### Step 17:

The server receives the correction content and merges it into the application document data. The server identifies the target document by its identifier, retrieves the current version, and applies the updates to the corresponding fields or text sections. The server resolves any conflicts using defined rules, updates timestamps, and stores the merged document as a new version in the database or file storage.
Input: correction request message and existing application document data.
Output: updated application document data incorporating the user's corrections.

### Step 18:

The server generates a third prompt sentence to analyze user emotion or operation history and adjust explanation or expression content. The server aggregates operation history data such as number of edits, time spent per section, and help requests, and converts this data into a descriptive text segment. The server combines this descriptive segment with instructions to infer an emotional state and construct appropriate guidance.
Input: operation history information and optional user feedback text.
Output: a third prompt sentence describing user behavior and requesting emotional state analysis and guidance style.

### Step 19:

The server sends the third prompt sentence to the generative AI model and receives an emotional state assessment and guidance suggestions. The generative AI model processes the behavioral description and returns categorized states such as confused, confident, or uncertain, together with recommended explanation styles. The server parses this output and maps it to internal parameters controlling length and tone of system messages.
Input: third prompt sentence.
Output: inferred emotional state and recommended explanation parameters.

### Step 20:

The server adjusts expression content or explanation content based on the inferred emotional state. The server selects explanation templates of different lengths or formality levels and may generate additional text segments with a further prompt sentence that specifies the desired style. The server updates guidance messages shown in the user interface and, if necessary, rewrites certain parts of the application document explanation sections to match the recommended style.
Input: emotional state and explanation parameters; existing explanation content.
Output: adapted expression and explanation content aligned with the user's inferred state.

### Step 21:

The server generates a fourth prompt sentence to verify presence or absence of mandatory description items in the application document data. The server concatenates all relevant sections of the current application document into a single text block and constructs a prompt that lists mandatory items such as objectives, methods, schedule, budget breakdown, and expected effects. The server instructs the generative AI model to label each item as sufficient, missing, or unclear.
Input: current application document text and a list of mandatory items.
Output: a fourth prompt sentence requesting completeness verification.

### Step 22:

The server sends the fourth prompt sentence and application text to the generative AI model and receives a verification result. The generative AI model analyzes the document text using its internal attention and language understanding layers and outputs a structured narrative indicating which mandatory items are covered or missing. The server parses this result, mapping each mandatory item to a status flag and optional explanation.
Input: fourth prompt sentence and application text.
Output: verification result indicating sufficiency, missing items, and unclear items.

### Step 23:

The server identifies missing items or unclear items from the verification result and prepares prompts for additional user input. The server associates each missing or unclear item with corresponding sections in the document and generates messages that describe what information is lacking. The server may generate refined instructions with another prompt sentence to produce user-friendly guidance phrased in natural language.
Input: verification result and mapping of document sections to mandatory items.
Output: guidance messages and markers indicating locations in the document that require additional input.

### Step 24:

The terminal presents the missing or unclear items and guidance messages to the user. The terminal updates the user interface to highlight sections needing attention, shows explanatory text, and provides input fields for the user to supply the required information. The user then inputs additional content, which the terminal captures and eventually sends back as further correction content.
Input: guidance messages and document markers from the server.
Output: user-facing prompts on the terminal interface and additional user input for document completion.

### Step 25:

The server generates the final application document data and transmits it to an external application reception apparatus. After all corrections and completeness checks are satisfied, the server freezes the current document version, converts it into the required final format (such as a signed PDF or structured XML), and attaches metadata including timestamps and scheme identifiers. The server then sends this final application document data via a network protocol such as HTTPS or a file transfer protocol to the external apparatus and stores a record of the transmission status.
Input: fully corrected and verified application document data.
Output: final application document data delivered to the external application reception apparatus and a stored submission status associated with the project.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented funding support systems typically provide only static search functions over funding scheme databases and rely heavily on manual input and manual document drafting by users. Even when natural language processing is applied, such systems often treat user input as a simple keyword source, without robust context extraction, structured feature derivation, or integration with downstream workflow stages such as automated document generation, user-driven revision cycles, and electronic submission. As a result, users must repeatedly reenter similar information into different forms, manually interpret complex eligibility criteria, and manually compose narrative sections of application documents, which increases latency, error rates, and resource consumption in the funding application process.

From a computer-technology perspective, existing systems do not effectively utilize generative AI models as programmable components in an end-to-end pipeline. In particular, the following technical issues arise: (i) the lack of a standardized mechanism for generating and managing prompt sentences that transform raw user input into structured characteristic information suitable for computation; (ii) the absence of integrated control logic that combines generative AI output with structured data operations, such as ranking of candidate funding schemes based on computed suitability indices; (iii) the absence of an architecture that consistently updates and persists application state while allowing iterative user edits on AI-generated drafts; and (iv) the lack of a coordinated interface for converting internal application representations into machine-readable submission files and reliably transmitting them to external information processing devices.

These limitations lead to inefficiencies in server-side resource utilization, fragmented data flows between natural-language analysis and relational data processing, and difficulty in ensuring traceable, repeatable processing when generative AI models are involved. There is therefore a need for a computer-implemented technique that systematically orchestrates receipt and normalization of user information, prompt-based interaction with a generative AI model, structured selection and ranking of funding schemes, automated generation and refinement of application documents, and controlled submission to external systems, while improving the consistency, reliability, and throughput of the underlying information processing.

The specific processing by the specific processing unit 290 of the data processing device 12 in Application Example 1 is realized by the following means.

The present invention provides a server comprising a processor configured to receive, via a communication network, user information from a user terminal and store the user information in an information management area of a storage device, to preprocess the stored user information into standardized text data and generate analysis prompt sentences that cause a generative AI model to output structured characteristic information including at least a business classification, a target field, region information, and related expressions, to execute query and ranking operations on a structured storage of funding scheme information using the characteristic information as search conditions so as to compute suitability indices and select optimal funding schemes, to acquire template information defining structures and items of application documents and generate application document draft data by associating and placing user information in the template items, to generate description-generation prompt sentences using structured data including the selected funding schemes and characteristic information as input conditions, to input the description-generation prompt sentences and the structured data into the generative AI model to obtain natural-language text and automatically embed the natural-language text into explanation items of the application document draft data, to transmit the draft data to the user terminal and iteratively update the draft data based on additional or corrective input from the user so as to store final application document data, and to convert the final application document data into an electronic document file in a submission format and transmit the electronic document file together with related metadata to an external information processing device. This enables a technically integrated, end-to-end processing pipeline in which the server coordinates natural-language understanding, structured data computation, document templating, and reliable electronic submission, thereby improving processing efficiency, reducing manual intervention, increasing consistency of data across stages, and enhancing the overall performance and reliability of computer-implemented funding support operations.
The term “user information” refers to data provided by a user through a user terminal, including at least text describing a business initiative, attributes of an organization, contact information, and other related contextual information that is processed by the server.
The term “user terminal” refers to an information processing apparatus operated by a user, such as a personal computer, a mobile communication device, or a tablet device, that communicates with the server via a communication network.
The term “communication network” refers to a wired or wireless data communication infrastructure, such as a local area network or a wide area network, through which the user terminal and the server exchange data.
The term “storage device” refers to a non-transitory computer-readable medium, including semiconductor memory, magnetic storage, optical storage, or a combination thereof, capable of storing instructions and data used by the processor.
The term “information management area” refers to a logically or physically defined storage region within the storage device that is used to store and manage user information, characteristic information, application document data, and related metadata.
The term “standardized text data” refers to text data obtained by normalizing user information, including operations such as character encoding unification, removal of unnecessary control characters, conversion of character width, and formatting adjustments, to provide consistent input for subsequent analysis.
The term “generative AI model” refers to a machine learning model, such as a neural network trained on large datasets, that generates or transforms natural-language text or other content based on input prompt sentences and input data.
The term “prompt sentence” refers to a text string or structured instruction provided as input to the generative AI model, which specifies a task, constraints, or a desired output format for the generative AI model.
The term “analysis prompt sentence” refers to a prompt sentence specifically designed to cause the generative AI model to analyze input text, extract structured information, or classify content, rather than merely generating free-form narrative text.
The term “description-generation prompt sentence” refers to a prompt sentence specifically designed to cause the generative AI model to generate explanatory or narrative text suitable for inclusion in an application document, based on structured data and contextual constraints.
The term “characteristic information” refers to structured attributes derived from user information by analysis, including at least a business classification, a target field, region information, and related expressions or keywords that can be used as search and ranking conditions.
The term “business classification” refers to a category or type of business activity, such as a sector, industry, or service type, that characterizes the nature of the user's initiative.
The term “target field” refers to a technical or thematic area, such as digitalization, infrastructure, or service improvement, that indicates the focus of the user's initiative.
The term “region information” refers to geographic information associated with the user or the initiative, such as a country, a region, or a locality, which is used for eligibility determination of funding schemes.
The term “related expressions” refers to words, phrases, or keywords that appear in or are inferred from the user information and that are relevant to the business initiative, technical field, or policy context.
The term “structured information storage area” refers to a storage region that holds data in a structured format, such as records in a database, including funding scheme information and associated attributes.
The term “funding aid scheme information” refers to structured data describing public or private financial support programs, including eligibility criteria, supported activities, funding limits, cost coverage ratios, deadlines, and other conditions.
The term “funding aid candidate information” refers to individual records or entries representing specific funding programs that are retrieved from the structured information storage area as potential matches for a user's initiative.
The term “suitability index” refers to a computed metric representing the degree of match between a particular funding aid candidate and the characteristic information of a user's initiative, calculated using rules or algorithms implemented by the processor.
The term “optimal funding aid information” refers to one or more funding aid candidate records selected as most appropriate for the user's initiative based on ranking by the suitability index or a related selection criterion.
The term “template information” refers to data defining a structure, sections, and fields of an application document, including layout, field names, and formatting rules used to generate application document drafts.
The term “application document draft data” refers to intermediate representation data of an application document in which at least some fields are automatically filled with user information or system-generated content, and which is subject to further editing.
The term “explanation items” refers to fields or sections within the application document that require narrative or descriptive text, such as project summaries, background explanations, objectives, implementation plans, and expected outcomes.
The term “natural-language text” refers to text data expressed in a human language and generated or transformed by the generative AI model, suitable for direct reading and interpretation by a human.
The term “final application document data” refers to application document data that has been updated based on user revisions to the application document draft data and has been designated as complete and ready for submission.
The term “electronic document file” refers to a computer-readable file that contains the contents of the final application document data in a specified submission format, such as a document or portable document representation acceptable by an external organization.
The term “submission format” refers to a prescribed data or file format, layout, or protocol required by an external organization for receiving application documents, which may include structural constraints, encoding rules, and metadata requirements.
The term “external information processing device” refers to a server, computer system, or other processing apparatus operated by an external organization, such as an administrative body or funding provider, that receives, processes, or stores submitted application documents.
The term “emotion-analysis prompt sentence” refers to a prompt sentence designed to cause the generative AI model to estimate or classify an emotional state expressed in user-provided text, such as neutrality, confidence, or urgency.
The term “emotional state information” refers to structured data indicating the detected or estimated emotional characteristics of user text, which can be used to adjust style, politeness, or emphasis in generated document descriptions.
The term “status information” refers to data indicating at least a selection result of optimal funding aid information and a progress state of creation of the final application document data, presented to the user through the user interface.
The term “history information” refers to log data or records maintained in the information management area that describe past events or actions, such as electronic document file transmissions, submission results, timestamps, and associated identifiers.
The term “user interface” refers to hardware and software components that present information to the user and receive input from the user, including graphical user interfaces, web interfaces, or application interfaces displayed on the user terminal.

In one embodiment, a server implements the claimed system as a network-connected information processing apparatus. The server includes at least one central processing unit (CPU), a main memory, a non-transitory storage device, a network interface, and an operating system such as a general-purpose server operating system. The server executes an application program implemented, for example, using an application framework (for instance, a web application framework) and a database engine such as a relational database management system. The server further communicates with an external generative AI model deployed on a separate computing environment via an application programming interface.

A terminal operates as a client-side device that a user manipulates. The terminal may be a personal computer running a web browser, a smartphone running a native application, or a tablet device. The terminal includes an input device, a display device, a local memory, and a communication module. The terminal executes a user interface application, such as a browser-based single-page application or a mobile application, to send and receive structured messages to and from the server via a communication network.

The server stores, on the storage device, multiple logical data regions, including at least an information management area, a structured information storage area for funding aid scheme information, a template storage area for application document templates, and a log area for recording prompts and responses related to a generative AI model. Each area is implemented, for example, as multiple relational tables in the relational database management system, with defined schemas that specify column types, indexes, and foreign-key relationships. The information management area stores user information, standardized text data, characteristic information, application document draft data, and final application document data.

The server processes user information obtained from the terminal by performing a sequence of structured data transformations. The server receives user input as structured data containing, at minimum, a free-form text field describing a funding-related initiative, along with metadata such as an organization identifier, an industry code, and a geographic code. The server normalizes the free-form text into standardized text data by applying deterministic text processing operations, for example, converting text to a canonical character set, unifying whitespace, expanding abbreviations according to a stored dictionary, and segmenting sentences. The server stores both the raw text and the standardized text data in the information management area with a unique identifier that binds all related records.

To derive characteristic information from the standardized text data, the server cooperates with a generative AI model. In one embodiment, the generative AI model is implemented as a transformer-based neural network that includes an embedding layer, a plurality of self-attention layers, and a final output layer trained for structured text generation. The generative AI model is trained on a corpus that includes annotated examples of business descriptions and funding-related categories. During training, the system minimizes a loss function such as a cross-entropy loss between predicted output tokens and ground-truth tokens, and updates model weights using a gradient-based optimization algorithm such as stochastic gradient descent with adaptive learning rate. Training data may be augmented using techniques such as synonym replacement and sentence reordering to increase robustness to user phrasing variations.

The server constructs an analysis prompt sentence based on the standardized text data. For example, the server generates a prompt sentence such as:
“Analyze the following initiative description and extract structured attributes in JSON-like notation with keys: industry, project_type, business_size, region, and policy_keywords. Initiative description: [user text].”

The server sends this prompt sentence and the standardized text data to the generative AI model over the network interface. The server formats the input as a sequence of tokens and receives a sequence of output tokens that represent a structured description. The server then parses the output to extract characteristic information, including at least a business classification, a target field, region information, and related expressions. The server stores the characteristic information as separate fields in the information management area. Because the server enforces a strict schema and validations (for example, mapping textual industry labels to predefined codes), the server achieves improved data consistency and reduced parsing error rates compared with naïve keyword detection.

The server uses the characteristic information as search conditions over the structured information storage area that holds funding aid scheme information. Each funding aid scheme record has predetermined fields such as an eligibility industry code set, a geographic applicability set, supported project types, minimum and maximum project budgets, and deadline dates. The server evaluates selection conditions using both exact matching and similarity scoring. For example, the server computes a suitability index by combining: (i) a binary indicator for each exact match between business classification and an eligibility industry code; (ii) a geographic match score computed by checking inclusion of the user's region in the scheme's coverage region; (iii) a similarity score between project_type and a list of supported project types based on vector representations of textual descriptions; and (iv) a penalty term derived from the temporal distance to the application deadline.

To efficiently compute similarity scores, the server may precompute vector embeddings for scheme descriptions using the same embedding model architecture used inside the generative AI model and store those vectors in the structured information storage area. The server then calculates cosine similarity between the embedding of the user's project_type and the embeddings of scheme descriptions. This hardware-assisted vector operation, combined with indexing on industry and region fields, reduces the search space significantly and yields fast, scalable retrieval performance even when the database contains a large number of funding schemes.

After computing the suitability index for each candidate funding aid scheme, the server ranks the schemes and selects one or more optimal funding aid schemes. The server then proceeds to construct application document draft data. The server retrieves template information corresponding to each selected scheme from the template storage area. Template information describes the application document structure as a tree of sections and fields, including field types (numeric, text, date), constraints (required, length limits), and layout properties. The server populates structured fields (such as organization name, address, and budget amount) directly from stored user information and characteristic information.

For explanation items in the application document, which require natural language descriptions, the server generates a description-generation prompt sentence. For example, the server may generate a prompt such as:
“Using the following project information and funding scheme requirements, generate a formal project summary of about 400 words suitable for a subsidy application. Emphasize alignment with digital payments promotion policies, expected impacts on transaction efficiency, and compliance with eligibility criteria. Project information: [structured data].
Funding scheme requirements: [scheme description].”

The server transmits the description-generation prompt sentence and the structured data to the generative AI model. The generative AI model, using its transformer architecture, performs attention over both the prompt and the structured data tokens to generate context-appropriate explanatory text. The server receives the generated natural-language text and inserts it into designated explanation items within the application document draft data, thereby binding structured selections and narrative content in a consistent manner.

The terminal presents the application document draft data to the user through a user interface. The terminal displays each structured field and explanation item in editable or read-only form according to the field definitions. The user can review the AI-generated explanations, adjust wording, and correct numerical values. The terminal records changes as a set of updated field values and transmits them back to the server. The server merges these updates into the stored application document draft data, preserving both the originally generated content and the user modifications in separate revision records to improve traceability and allow differential analysis between AI-generated and user-edited text.

In one embodiment, the server further adjusts the style of generated text based on emotional state information derived from user-provided text. The server constructs an emotion-analysis prompt sentence such as:
“Estimate the predominant emotional tone (e.g., neutral, confident, concerned, urgent) of the following text and output a single label. Text: [user text].”

The server obtains an emotional state label from the generative AI model and maps this label to style parameters, such as formality level and degree of emphasis. The server then modifies the description-generation prompt sentence accordingly, for example, by adding instructions such as “use a neutral and highly formal tone” or “use a confident and assertive tone while remaining formal.” This parameterized prompting and structured mapping improves the predictability and reproducibility of text style adjustments, which addresses a technical issue in controlling generative models for document creation.

After the user confirms the application document draft data, the server designates the data as final application document data. The server converts the internal representation into an electronic document file in a submission format. For example, the server may use a document rendering engine running on the same server or on a separate rendering node to transform a structured markup representation (such as HTML-like layout markup) into a portable document format file. The server then attaches metadata such as scheme identifier, submission timestamp, and checksum, and stores a pointer to the generated file in the information management area.

To communicate with an external information processing device operated by a funding provider, the server establishes a secure communication channel via the network interface. The server may use an application-level protocol such as a RESTful API or a file transfer protocol. The server transmits the electronic document file and associated metadata to the external device. The external device can automatically ingest and process the submission because of the consistent structural alignment between internal templates and external format specifications. The server records the transmission result as history information, including any response or tracking identifier returned from the external device.

From a technical standpoint, this configuration provides improvements beyond mere automation of human tasks. The server integrates prompt-based interaction with a generative AI model into a deterministic, schema-driven data processing pipeline. By enforcing standardized text representations, mapping outputs of the generative AI model to strict schemas, and combining the mapped results with optimized database queries and vector similarity operations, the server achieves measurable improvements, including (i) reduced end-to-end processing time for funding scheme selection and document drafting, (ii) lower error rates in mapping user initiatives to eligibility conditions, and (iii) improved consistency between narrative content and structured eligibility attributes.

Furthermore, the server uses non-conventional prompt generation and structured control logic to constrain the generative AI model. Instead of allowing arbitrary natural-language generation, the server encodes explicit constraints and desired output formats into analysis prompt sentences and description-generation prompt sentences. This yields more stable and predictable outputs and reduces the need for post-hoc human corrections, thereby reducing unnecessary communication cycles between the server and the terminal and lowering network and computation load.

In another embodiment, the server divides the generative AI workload between multiple model variants. A smaller, faster model instance may be used for classification-oriented analysis prompts, while a larger model instance may be used for long-form description generation. The server selects the appropriate model instance based on the type of prompt sentence and the expected output length. This dynamic routing of prompts improves computational efficiency, as the server avoids invoking large models for simple classification tasks. The server may record per-task latency and success metrics and adjust model selection thresholds over time to further optimize performance.

The terminal, by offloading most computationally intensive processing to the server and generative AI model, can remain lightweight and consume fewer local resources. The terminal is primarily responsible for input capture, display rendering, and user interaction. Because the server transmits structurally rich, pre-validated draft data to the terminal, the terminal does not need complex validation logic and can use straightforward rendering code to present dynamic forms. This separation of concerns simplifies terminal implementation and contributes to reduced client-side processing overhead.

In still another embodiment, the server maintains multiple template variants for different external organizations, languages, or document formats in the template storage area. The server selects and combines template segments based on the optimal funding aid information and the user's region information. This template modularization enables the server to reuse common sections while adapting to specific submission formats, leading to reduced storage redundancy and improved maintainability of templates. The server's ability to systematically assemble templates and feed the structured template layout into the generative AI model through precise prompt sentences results in more accurate layout-aware content generation.

By structuring the system in this way, the server does not merely implement a generic “data input-analysis-output” sequence, but instead executes a specific sequence of technical operations on defined data structures using particular model architectures and database algorithms. This yields tangible technical benefits in the areas of processing speed, accuracy of classification and matching, document consistency, and efficient network and storage usage, and thereby improves the functioning of the computer systems that implement funding-related document generation and transmission.

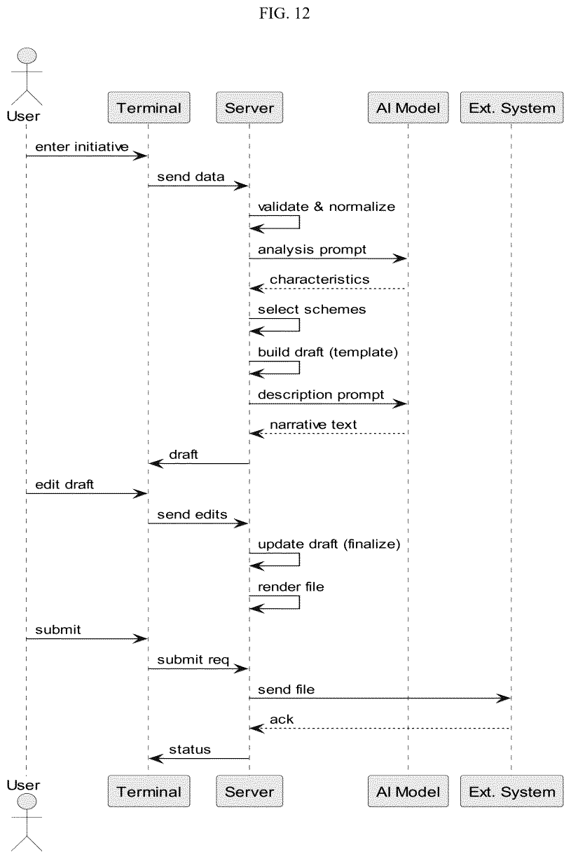

The following describes the processing flow using FIG. 12.

### Step 1:

The user operates the terminal to start an application screen and inputs initiative information such as a project description, organization profile, and basic parameters (industry, location, approximate budget). The terminal receives this raw input as multiple text and numeric fields and packages the fields into a structured message (for example, a JSON object) including a user identifier and a timestamp as input. The terminal sends this structured message to the server via a communication network using a request such as an HTTPS POST. The output of this step is a network request containing user information delivered to the server.

### Step 2:

The server receives the network request as input and validates the structure and content of the user information. The server checks that required fields are present, verifies that text fields do not exceed size limits, and confirms that numeric fields conform to expected ranges. The server then performs data processing on the free-form text fields by normalizing characters, unifying encodings, trimming whitespace, and splitting the text into sentences. Based on this processing, the server generates standardized text data as an internal representation that is less ambiguous and more suitable for later analysis. The server stores both the raw user information and the standardized text data in an information management area of a storage device, creating database records linked by a unique initiative identifier. The output of this step is persistent storage of validated user information and standardized text data, referenced by the initiative identifier.

### Step 3:

The server uses the standardized text data as input to construct an analysis prompt sentence for a generative AI model. The server concatenates a fixed instruction string and the standardized text data, for example:
“Analyze the following initiative description and extract structured attributes with keys: industry, project_type, business_size, region, policy_keywords. Initiative description: [standardized text].”

The server generates this prompt sentence and sends both the prompt sentence and the standardized text data to the generative AI model via an API call. The generative AI model receives the prompt and computes output tokens representing structured attributes by applying attention mechanisms and learned weights of its neural network. The server receives the generated text as output of the model and parses it into structured characteristic information, including business classification, target field, region information, and related expressions. The output of this step is a set of characteristic information records associated with the initiative identifier.

### Step 4:

The server takes the characteristic information as input for a database search. The server formulates query conditions using the business classification, target field, region information, and related expressions as search parameters. The server then executes database queries on a structured information storage area that holds funding aid scheme information. Internally, the server performs data operations such as: filtering schemes by compatible industry codes, checking region coverage, computing text similarity scores between the project_type attribute and scheme descriptions using pre-stored vector embeddings, and aggregating scores into a suitability index. The server ranks all candidate schemes by the suitability index, selects the top candidates, and designates at least one as optimal funding aid information. The output of this step is a ranked list of funding aid candidates and the selected optimal funding aid information.

### Step 5:

The server uses the optimal funding aid information and the stored user information as input to generate application document draft data. The server retrieves template information corresponding to the selected funding scheme from a template storage area. The server then maps fields from user information and characteristic information to the placeholders defined in the template, for example, placing the organization name, address, and budget values into corresponding fields. The server performs data formatting operations, such as converting dates to a specified pattern and ensuring numeric precision for budget amounts. For fields defined as explanation items, the server initially leaves them empty or marks them as pending generation. The output of this step is a partially populated application document draft structure, stored under the initiative identifier.

### Step 6:

The server uses the partially populated application document draft structure and the characteristic information as input to generate explanation items. The server constructs a description-generation prompt sentence such as:
“Using the following project information and funding scheme requirements, generate a formal project summary of about 400 words suitable for a subsidy application. Emphasize alignment with policy goals, expected impacts, and compliance with eligibility criteria. Project information: [structured project data]. Funding scheme requirements: [scheme description].”

The server sends this prompt sentence together with the structured project and scheme data to the generative AI model. The generative AI model processes the input and outputs natural-language text that satisfies the requested style and content constraints. The server receives this generated text and automatically inserts it into the explanation items of the application document draft structure. The output of this step is an application document draft in which both structured fields and narrative explanation items are filled.

### Step 7:

The server transmits the filled application document draft as input to the terminal, using a structured response that includes all fields and explanation items. The terminal receives the draft and renders the fields on a graphical user interface, distinguishing between read-only and editable items. The user views the displayed draft and, based on the content, inputs edits such as correcting numerical values, updating descriptions, or adding missing details. The terminal captures these differences as updated field values and sends them back to the server as an update request. The server receives the updated data, validates the changes, and applies a data update operation that merges user edits into the stored draft, preserving a version history if needed. The output of this step is updated application document draft data that reflects user corrections.

### Step 8:

The user confirms that the updated application document draft is acceptable and issues a finalize instruction through the terminal. The terminal sends a finalize command along with the initiative identifier as input to the server. The server receives this instruction and transforms the status of the corresponding application from “draft” to “final” in the information management area. The server then defines the current state of the document structure as final application document data, freezing further automatic modifications. The output of this step is stored final application document data associated with a status indicating readiness for submission.

### Step 9:

The server uses the final application document data as input to generate an electronic document file. The server converts the internal structured representation into a layout description, and then invokes a document rendering component to produce a file in a submission format, such as a portable document format file. During this process, the server embeds all text, numeric fields, and necessary metadata into the file and computes integrity information such as checksums. The server stores the generated electronic document file in a file storage area and records a reference to the file in the information management area. The output of this step is an electronic document file ready to be transmitted and a storage record linking the file to the initiative identifier.

### Step 10:

The server receives a submission instruction from the terminal as input, together with identifiers for the final application document data and target external organization. The server verifies that the electronic document file exists and that all mandatory fields in the final application document data are present. If validation is successful, the server establishes a communication session with an external information processing device operated by the funding provider. The server transmits the electronic document file and associated metadata over this session, using a defined protocol such as HTTPS or a file transfer protocol. The external device receives and acknowledges the submission, returning a status code or tracking identifier. The server records the submission outcome, including timestamps and any external identifier, in history information within the information management area. The output of this step is an updated submission history record indicating successful or failed transmission to the external information processing device.

### Step 11:

The user later requests status information through the terminal as input, selecting an initiative identifier or viewing a list of past applications. The terminal sends a status inquiry to the server. The server receives the inquiry and reads the corresponding status fields and history information from the information management area, including current processing status, submission timestamps, and any responses from the external device. The server aggregates this information and formats it into a response that includes both a concise status label and detailed history records. The terminal receives this response and displays the status information to the user in a human-readable form. The output of this step is a visual presentation of up-to-date status information regarding the funding application process.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented funding application systems typically act as static form-filling tools. In such systems, a processor merely stores user-entered text, performs simple keyword matching against a funding program list, and presents fixed templates for application documents. These approaches suffer from several technical limitations.
First, the processor is not configured to perform robust natural language analysis of user input. As a result, the system often fails to correctly identify the true category, intent, and contextual nuances of a user's activity description, leading to low-precision matching between the user's activity and available funding programs. This causes the computing resources used for searching and ranking funding programs to be inefficiently consumed, because the search and ranking logic operates on coarse or noisy signals.
Second, conventional systems do not systematically integrate a generative AI model into the data processing pipeline at the level of internal prompt construction, structured data generation, and iterative document regeneration. In typical implementations, if a generative model is used at all, it is invoked in an ad hoc manner to produce free-form text, without tightly coupling the generated output to structured data in storage or to downstream database search operations. This lack of integration prevents the processor from effectively using the model's output as machine-usable structured information (for example, classification information and keyword information) across multiple processing stages, such as funding program selection and document generation.
Third, known systems generally treat application documents as static artifacts. Once a document is generated, user edits are often applied directly to the final file format (for example, a word processing file or a portable document file) without updating the underlying data structures. This breaks the linkage between user edits and the structured data in the storage device, making it difficult for the processor to automatically regenerate consistent versions of the document, manage versions programmatically, or reuse the structured content for other purposes. As a result, iterative refinement of documents requires repeated manual operations by the user and repeated, redundant rendering work by the processor.
Fourth, in many implementations, the interaction with the generative AI model is limited to naive prompt sentences that do not encode system-level constraints, such as search conditions for funding programs or structural requirements for application documents. This prevents the processor from obtaining analysis results that are tailored to the system's internal data schema and processing pipeline. Consequently, additional ad hoc parsing and normalization steps are required, increasing processing complexity and latency in the computing environment.

Accordingly, there is a need for a system and computer-implemented technique that improves computer technology by: (i) configuring a processor to construct and use prompt sentences that integrate activity information and system constraints; (ii) obtaining, from a generative AI model, structured classification and keyword information optimized for funding program search and document generation; (iii) using such structured information to carry out efficient database search and ranking for funding programs; and (iv) maintaining the user-edited content as structured data so that the processor can automatically regenerate, version, and output application documents in a consistent and efficient manner. Such improvements can reduce redundant processing, enhance the precision of funding program selection, and enable more reliable and automated generation of application documents in a computing system.

The specific processing by the specific processing unit 290 of the data processing device 12 in Example 2 is realized by the following means.

The present invention provides a server comprising a processor configured to receive, via a terminal, activity information expressed in natural language from a user, convert the activity information into structured data, and store the structured data in a storage device; generate a prompt sentence including the structured activity information and constraint information indicating search conditions for funding programs and structural requirements for application documents, and cause a generative AI model to execute natural language analysis processing based on the prompt sentence to obtain classification information and keyword information corresponding to the activity information; perform a database search on funding program information stored in a database by using the classification information and the keyword information as search parameters, evaluate relevance of candidate funding programs, and select an optimal funding program; generate, based on application requirement information of the selected funding program and the structured activity information, structured data for individual entry items of an application document, and format a template based on a document description language by using the structured data to automatically generate an electronic document having a predetermined format; generate display data corresponding to the electronic document, transmit the display data to the terminal so that the user can confirm and edit content of the electronic document, receive edit content from the terminal, and update the structured data and the electronic document based on the edit content; and manage versions of a plurality of electronic documents regenerated from the updated structured data and store a final electronic document as a document for submission. This enables an improvement in computer technology whereby the processor cooperatively uses internally constructed prompt sentences and generative AI model outputs as structured data across multiple processing stages, thereby enhancing the precision and efficiency of funding program selection, reducing redundant document processing, and allowing automated, version-controlled regeneration and output of application documents within a computing system.
The term “processor” refers to one or more hardware computation units or processing cores that execute machine-readable instructions to perform the described operations, including receiving data, generating prompt sentences, invoking a generative AI model, performing database searches, generating documents, and managing versions of electronic documents.
The term “terminal” refers to any electronic apparatus having an input unit and a display unit, such as a client computing device, that communicates with the server and allows a user to input activity information, view generated electronic documents, and submit edit content.
The term “user” refers to a human operator who interacts with the terminal and the system by providing activity information, reviewing electronic documents, and inputting edit content or submission instructions.
The term “activity information” refers to information representing a planned or ongoing project, program, or initiative, expressed in natural language, including at least a purpose, content, schedule, and other descriptive attributes relevant to funding.
The term “natural language” refers to a human language, such as a spoken or written human language, as opposed to a programming language or markup language, that is directly understandable by human users.
The term “structured data” refers to data organized according to a predetermined data model or schema, such as key-value pairs, records, fields, or tables, which can be stored, searched, and processed by the processor and a database management system.
The term “storage device” refers to any computer-readable memory, including volatile memory and non-volatile memory, configured to store structured data, electronic documents, and related metadata used in the system.
The term “prompt sentence” refers to one or more machine-readable text strings that include at least part of the activity information and optionally constraint information, and that are provided as an input to a generative AI model to cause the model to perform a specified analysis or generation task.
The term “constraint information” refers to information included in a prompt sentence that specifies conditions, limitations, or structural requirements for processing by the generative AI model, including search conditions for funding programs and structural requirements for application documents.
The term “generative AI model” refers to a machine-learned model configured to generate or transform natural language text in response to a prompt sentence, and capable of performing tasks such as classification, keyword extraction, and text generation.
The term “natural language analysis processing” refers to processing in which the generative AI model interprets activity information contained in a prompt sentence to derive structured outputs, including classification information and keyword information, based on the semantics of the natural language input.
The term “classification information” refers to information indicating one or more categories, classes, or types to which the activity information belongs, such as domains, sectors, or thematic areas used for matching funding programs.
The term “keyword information” refers to one or more terms or phrases extracted from, or derived from, the activity information that represent salient concepts, attributes, or topics relevant to the activity, and that are usable as search parameters.
The term “database” refers to an organized collection of data managed by a database management system, configured to store and provide access to funding program information, activity information, analysis results, and electronic document metadata.
The term “funding program information” refers to data describing funding schemes, financial aid programs, or subsidy frameworks, including attributes such as eligibility criteria, categories, keywords, application requirements, funding amounts, and deadlines.
The term “candidate funding programs” refers to one or more funding programs retrieved from the database based on the classification information and the keyword information, and considered as potential matches for the activity.
The term “relevance evaluation processing” refers to processing in which the processor computes a measure of match or suitability between the activity information and each candidate funding program, based on parameters such as category overlap, keyword overlap, and program constraints.
The term “optimal funding program” refers to one or more funding programs selected from among candidate funding programs according to a relevance evaluation result, such that the selected funding programs are determined to be most suitable for the activity.
The term “application requirement information” refers to information describing conditions, sections, fields, or constraints that must be satisfied or filled in when preparing an application document for a funding program.
The term “entry item of an application document” refers to a predefined section, field, or paragraph of an application document that is to be populated with content, such as a project overview, objectives, implementation plan, budget, or expected outcomes.
The term “document description language” refers to a markup or typesetting language for describing structure and layout of documents, which is used to define a template and to generate a formatted electronic document.
The term “template” refers to a predefined document structure expressed in a document description language, including placeholders or variables for entry items that are to be populated with structured data related to the activity and the funding program.
The term “electronic document having a predetermined format” refers to a computer-readable file generated from a template and structured data, having a specified layout, structure, and content arrangement suitable for submission to a funding program.
The term “display data” refers to data generated by the processor and transmitted to the terminal for rendering a visual representation of the electronic document or its contents on a display unit.
The term “edit content” refers to modifications, additions, deletions, or corrections to the content of an electronic document, input by the user via the terminal and transmitted to the server for updating the structured data and the document.
The term “version management” refers to the process of generating, storing, and identifying multiple versions of electronic documents derived from structured data, and maintaining associations between versions and corresponding activity or funding program information.
The term “final document for application” refers to a designated version of an electronic document that has been updated and confirmed, and that is stored for use in submitting an application to a funding program.
The term “transmission or output of the final document” refers to operations by which the final document is electronically sent to an external system, made available for download, printed, or otherwise provided for use in the funding application process.

In one embodiment, a server, a terminal, and a network cooperate to implement the claimed system for selecting a funding program and generating an application document. The server includes at least one processor, a main memory, a non-volatile storage device, and a network interface. The terminal includes a processor, a memory, an input device, and a display device. The server and the terminal are connected via a communication network such as the Internet or a local area network.

The server executes an application program implemented, for example, using a server-side runtime environment, a web framework, and a database management system. The server uses a relational database management system such as a structured query language (SQL) database to store structured data including activity information, analysis results, funding program records, and document metadata. The server further runs a document preparation subsystem using a document description language such as a markup-based typesetting language. The server also accesses a generative AI model deployed either locally on a graphics processing unit (GPU) server or remotely via an application programming interface (API).

The terminal executes a client-side application such as a web browser or a native application. The terminal presents user interface screens, receives natural language input from a user, displays document previews, and transmits user edits to the server over a secure communication protocol such as HTTPS. The user interacts with the system via the terminal, but the terminal and the server perform substantial data processing steps that transform user input into structured data, search results, and formatted documents.

In one example configuration, the server uses a multi-layer neural network as the generative AI model. The neural network is implemented as a transformer-based architecture that includes an embedding layer, multiple self-attention layers, feed-forward layers, and an output layer. The generative AI model is trained on large-scale corpora of natural language documents. During training, the server supplies tokenized text sequences to the model, computes a loss function such as cross-entropy between predicted tokens and ground-truth tokens, and updates model weights using a gradient-based optimization algorithm such as stochastic gradient descent or Adam. The server can apply regularization techniques and data augmentation such as random masking, sequence truncation, or noise injection during training to improve generalization.

The server uses the generative AI model in inference mode to obtain classification information and keyword information from activity information provided by the user. The server embeds the user's natural language activity description into numeric vectors using a tokenization and embedding process. The server then propagates these embeddings through the layers of the transformer network. Attention mechanisms within the network compute context-dependent representations that capture long-range dependencies between words and phrases in the activity description. The network outputs probability distributions over tokens or labels, from which the server derives structured outputs such as categories and keywords. Because the network captures semantic relationships beyond simple string matching, the server can obtain more accurate and context-aware analysis results than with conventional rule-based or keyword-only methods.

The server stores the activity information and the derived classification information and keyword information as structured data. The server, for example, maintains a table for projects or activities, in which fields such as an identifier, a title, a purpose, an activity description, dates, and a location are stored. The server maintains another table for analysis results, in which fields such as categories, keywords, model name, and analysis time are stored. The server uses a normalized schema so that the structured data can be efficiently joined and queried in combination with funding program records.

The server also stores funding program information in the relational database. For each funding program, the server stores data including an identifier, a program name, valid categories, critical keywords, eligibility conditions, application deadlines, and required sections of an application document. The server may store indexing information such as inverted indexes or pre-computed category mappings to accelerate searches. The server uses these structured records to perform a multi-stage search and ranking process. In one variant, the server computes similarity scores by counting overlapping categories and keywords and by applying weighting factors to more important terms. In another variant, the server computes vector embeddings for both the activity information and the funding program descriptions and computes cosine similarity between the embeddings.

The server generates a prompt sentence for the generative AI model by incorporating the user's activity information and constraint information related to the funding domain and document structure. The server composes the prompt sentence as a plain text string that includes explicit instructions. An example of such a prompt sentence is:
“You are a classification assistant for funding applications.

Here is a project description:
Title: ‘Regional Forest Restoration Project’
Purpose: ‘To restore local forests through tree-planting activities.’
Activities: ‘We will plant 5,000 native trees over three years and involve local residents in regular maintenance events.’
1. Classify this project into up to three categories such as environment, forestry, regional revitalization, education, or others.
2. Extract 5 to 10 important keywords for this project.
3. Return the result conceptually as a set of categories and a set of keywords that can be used for database search.”

In another embodiment, the server includes in the prompt sentence further constraint information about the required sections of an application document, for example:
“You are preparing text for a funding application.

Here is the project description and the target category ‘environment/forestry’.

Please generate a clear and concise ‘Project Overview’ section (200-300 words) suitable for a government funding application.

Consider that the document will later be formatted into predefined sections: ‘Project Overview’, ‘Implementation Plan’, ‘Budget Plan’, and ‘Expected Outcomes’.”

By explicitly including search-related constraints and document-structure constraints in the prompt sentence, the server guides the generative AI model to produce outputs that are not free-form text, but are instead aligned with internal data schemas and processing requirements. This reduces the need for post-processing heuristics and thereby improves computational efficiency and reliability.

The server uses the classification information and keyword information returned from the generative AI model as features in a ranking algorithm implemented on the server. The server, for instance, converts categories into numerical vectors, assigns a weight to each category and keyword, and computes a relevance score as a weighted sum. The server normalizes scores and applies thresholding to discard low-scoring candidates. This algorithmic treatment of the generative AI outputs as structured, machine-usable features represents a technical improvement over systems that only display generative text to the user without integrating it into database search logic.

The server generates application documents using a document description language template stored on the storage device. The server stores templates with placeholders for entry items such as project title, project overview, implementation plan, budget, and expected outcomes. The server maps each placeholder to a field of the structured data stored in the database. When the server generates a document, the server retrieves relevant structured data, populates a template instance with the data, and produces source text in the document description language. The server then invokes a document compiler to generate a formatted document, such as a portable document file. Because the server uses structured data to populate templates, small changes in the structured data can be reflected consistently in all occurrences of the information within the document.

The terminal displays a representation of the generated electronic document to the user. The server transmits either a formatted document or a rendered view corresponding to each section. The terminal shows text fields in which the user can modify parts of the document, such as the wording of the project overview or the details of an implementation schedule. The terminal then sends the edited text back to the server. The server converts the edited text into updated structured data, ensuring that the underlying records in the database remain synchronized with the user-visible content.

The server applies version management by assigning a version identifier to each instance of the electronic document. Whenever the structured data is updated based on user edits, the server regenerates the document from the updated structured data, saves the new version, and maintains a link between project identifiers, funding program identifiers, and document versions. This versioned regeneration approach ensures reproducibility and consistency. It also reduces errors that might occur if a user were to directly edit only the visual representation of the document. The server can, for example, compare versions to detect changes and apply differential storage to reduce memory usage.

The described configuration improves computer technology in several respects. The server uses a generative AI model not as a black box that simply generates text, but as a component in a structured processing pipeline. The server carefully constructs prompt sentences that encode both user activity information and internal constraints. The server converts natural language into structured classification and keyword features that are then fed into subsequent algorithms for database search and document generation. This integrated data flow reduces the number of ad hoc text parsing steps and avoids repeated manual categorization, leading to lower processing latency and more deterministic behavior.

The server improves precision in matching activities to funding programs by leveraging deep contextual representations from the transformer-based generative AI model. Traditional keyword-based systems may treat two words as unrelated if they differ in surface form. In contrast, the described system uses dense embeddings and attention mechanisms inside the generative AI model to capture semantic similarity, so that semantically related phrases are recognized even if they are lexically different. This improves the recall and precision of the search process, resulting in more suitable funding program recommendations. The improved matching reduces unnecessary user interactions and decreases the amount of redundant network traffic caused by repeated queries.

The server also improves document generation and management efficiency. By storing all essential content as structured data and regenerating documents from templates, the server ensures that any correction by the user is propagated consistently across all dependent sections and versions. This reduces the risk of inconsistency and human error. The server can automatically generate multiple document formats—such as a formatted document for printing and a lightweight representation for on-screen review—from the same structured source, reducing duplicate authoring and transformation tasks. This leads to reduced computational overhead and improved maintainability.

The use of version management for electronic documents provides a technical advantage over static file storage. The server can store only differences between versions, or can compress archived versions, thereby reducing storage requirements. The server can also selectively retrieve prior versions for audit or rollback, which is useful in regulated environments. Because the system controls the versioning centrally at the server, the risk of divergence between copies of documents on different terminals is reduced.

The generative AI model in the system is trained using a specific procedure that further contributes to technical improvements. The server uses a training dataset comprising activity descriptions and labels such as categories and keywords. The server feeds each training example into the neural network, computes a loss using, for example, a combination of a token prediction loss and a classification loss, and adjusts network weights accordingly. The server may employ mini-batch training, learning rate scheduling, and early stopping to optimize performance. The server may also perform fine-tuning of the model using domain-specific funding-related texts, improving the model's robustness and accuracy when dealing with domain-specific expressions. As a result, the model can more reliably interpret complex project descriptions, which in turn enables the server to perform more accurate categorization and keyword extraction.

In a further embodiment, the server uses a hybrid rule-based and model-based approach. The server maintains a rule set that enforces business constraints, such as excluding programs whose deadlines have passed or whose required location conditions do not match the activity location. The server combines the generative AI model's outputs with the rule-based filters. This non-conventional combination produces more reliable results: the model provides rich semantic understanding, while the rules ensure compliance with hard constraints. The server uses a defined priority scheme for resolving conflicts, such as prioritizing rule-based exclusion over model-based similarity scores. This combination of neural inference and deterministic rule evaluation improves both precision and robustness of the selection system.

In another embodiment, the server locally deploys the generative AI model on specialized hardware such as GPUs or tensor processing units. The server manages a queue of inference requests and batches multiple requests together to exploit parallel computation on the hardware accelerator. The server also caches frequent analysis results, so that repeated queries involving similar or identical activity descriptions can be served from cache. These mechanisms contribute to improved throughput and reduced latency, which are technical benefits at the system level.

In a variant, the server uses an alternative data structure for storing funding program information, such as a graph database or a document store. In this variant, the server represents relationships between categories, keywords, and programs as edges in a graph. The server performs graph traversal and similarity computation using the classification information and keyword information as starting nodes. This structure can further improve performance for complex queries involving multiple relationships, demonstrating that the invention is not limited to a specific database engine but instead focuses on the structured use of generative AI outputs for efficient search.

In all described embodiments, the server, the terminal, and the generative AI model cooperate according to explicit data flows and algorithms that go beyond mere automation of human mental steps. The server constructs prompt sentences in a machine-optimized format, transforms natural language into structured data using learned representations, and integrates that data into database queries and document generation workflows. The server thereby improves processing speed, matching precision, and data consistency, providing a technical solution grounded in computer architecture, data structures, and algorithmic design rather than solely in a business or administrative idea.

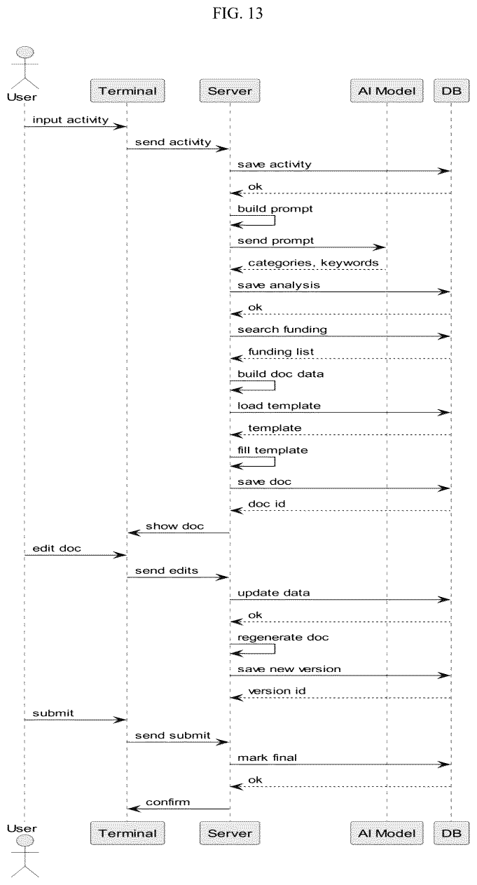

The following describes the processing flow using FIG. 13.

### Step 1:

The user operates the terminal to access an application screen provided by the server.

The terminal displays input fields for activity information, including fields such as title, purpose, activities, schedule, and location.

The user enters natural language text into these fields, for example: “To restore local forests through community-based tree-planting activities starting in April next year.”

The terminal validates the format of simple items (for example, date fields) and converts the entered values into a structured request object.
Input: raw keystrokes and touch events from the user.
Output: a structured activity information object in a client-side format ready to be transmitted to the server.

### Step 2:

The terminal sends the structured activity information to the server via a network using a request message.

The server receives the request, parses the message body, and converts it into internal data structures such as records or objects.

The server writes the received activity information into a persistent storage device using a database interface, assigning a unique identifier to the activity.
Input: the structured activity information object transmitted from the terminal.
Output: a stored activity record in the database, including a newly assigned activity identifier returned to the terminal or retained internally by the server.

### Step 3:

The server constructs a prompt sentence for a generative AI model by embedding the stored activity information into a template.

The server inserts the title, purpose, and activities text into the template and appends explicit instructions regarding classification and keyword extraction.

For example, the server generates a prompt sentence such as:
“You are a classification assistant for funding applications.

Here is a project description:
Title: ‘Regional Forest Restoration Project’
Purpose: ‘To restore local forests through tree-planting activities.’
Activities: ‘We will plant 5,000 native trees over three years and involve local residents in regular maintenance events.’
1. Classify this project into up to three categories such as environment, forestry, regional revitalization, education, or others.
2. Extract 5 to 10 important keywords for this project.
3. Return the result conceptually as a set of categories and a set of keywords that can be used for database search.”

The server concatenates the strings and encodes them into a format suitable for the generative AI model interface.
Input: the stored activity information retrieved from the database.
Output: a complete prompt sentence string ready to be supplied to the generative AI model.

### Step 4:

The server sends the prompt sentence to the generative AI model through an inference interface, specifying parameters such as maximum length and decoding strategy.

The generative AI model internally tokenizes the prompt, maps tokens to embedding vectors, propagates them through attention layers and feed-forward layers, and generates token probabilities for classification labels and keyword candidates.

The server receives the model output, which may contain textual labels and keyword phrases, and parses the output to extract explicit category names and keywords.

The server normalizes the extracted items by converting them to a canonical case, removing duplicates, and trimming whitespace.
Input: the prompt sentence created by the server.
Output: structured classification information and keyword information derived from the activity description.

### Step 5:

The server stores the classification information and keyword information in association with the corresponding activity record in the database.

The server inserts or updates a record that links the activity identifier to one or more category values and a list of keywords.

The server uses a defined schema, for example, a table for categories and another for keywords, to enable efficient querying.
Input: the structured classification information and keyword information returned from the generative AI model.
Output: persistent analysis records in the database that can be joined with activity and funding program records.

### Step 6:

The server performs a search over funding program records stored in the database using the classification information and keyword information as search parameters.

The server constructs a query that filters programs by overlapping categories and counts occurrences of keywords within program descriptions, eligibility criteria, and tags.

The server computes a relevance score for each candidate program by applying a scoring formula, for example, assigning weights to category matches and keyword matches and summing them.

The server sorts the candidate programs by relevance score and selects one or more top-ranked funding programs as optimal candidates.
Input: the classification information and keyword information associated with the activity.
Output: a ranked list of candidate funding programs, including selected optimal funding programs.

### Step 7:

The server retrieves detailed requirement information for the selected funding program from the database, including required sections of the application document and any mandatory fields.

The server constructs structured document data by mapping activity information and program requirement fields to logical document sections such as project overview, implementation plan, budget explanation, and expected outcomes.

In one variation, the server optionally generates an additional prompt sentence to the generative AI model to refine or expand certain sections, for example:
“You are preparing text for a funding application.

Here is the project description and the target category ‘environment/forestry’.

Please generate a clear and concise ‘Project Overview’ section (200-300 words) suitable for a government funding application.”

The server receives the generated section text and inserts it into the structured document data.
Input: the selected funding program information and the existing activity information, optionally combined with additional generative AI output.
Output: structured document data representing all entry items required for the application document.

### Step 8:

The server creates a document template instance based on a document description language and fills placeholders with the structured document data.

The server replaces placeholder tokens corresponding to project title, overview, implementation details, schedule, budget, and outcomes with the textual content derived from the structured data.

The server invokes a document compiler or formatter that reads the filled template and generates a formatted electronic document, such as a file ready for display or printing.

The server stores the generated electronic document and associates it with the activity and funding program identifiers in the database.
Input: the structured document data representing the content of the application document.
Output: a formatted electronic document file and corresponding metadata stored in the system.

### Step 9:

The server generates display data for the terminal by converting the content of the electronic document into web-friendly or application-friendly representations, such as HTML sections with editable fields.

The terminal receives the display data and renders the application document on the screen, showing both a visual layout (for example, a preview pane) and editable text boxes for each section.

The user reviews the displayed content and enters modifications, additions, or corrections to sections such as the project overview or schedule details.

The terminal collects the edited text and packs it into an update request to be sent back to the server.
Input: the formatted electronic document and structured data retrieved by the server.
Output: rendered document views on the terminal and an edit request containing user-modified content.

### Step 10:

The server receives the edit request from the terminal and parses the modified fields.

The server updates the corresponding structured data records in the database, overwriting or appending to the previous values for the affected sections.

The server generates a new version identifier and triggers regeneration of the electronic document using the updated structured data and the same template.

The server compiles the updated template into a new electronic document file, stores it with the version identifier, and keeps links between versions and the underlying activity and program.
Input: user edit content for one or more sections of the application document.
Output: updated structured data records and a newly generated version of the electronic document stored with version control.

### Step 11:

The terminal requests the latest version of the application document from the server to confirm that the edits have been correctly applied.

The server retrieves the latest version based on the version identifier and generates corresponding display data.

The terminal displays the updated document to the user, who verifies the content and, when satisfied, operates a control such as a “Submit Application” button.

The terminal sends a submission request referencing the final version identifier to the server.
Input: the user's confirmation operation and the request for the final document version.
Output: a submission request indicating that the latest document version is designated as the final application document.

### Step 12:

The server receives the submission request and marks the corresponding document version as final in the database.

The server records submission metadata such as timestamp, submitting user, and target funding program identifier.

The server optionally transmits the final electronic document to an external system or stores it in a designated submission repository.

The server generates a confirmation response containing application identifiers and submission status and sends it to the terminal.
Input: the submission request specifying the final document version.
Output: a stored final application record and a confirmation response delivered to the terminal for display to the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional computer-implemented systems for preparing funding or subsidy applications, the computing devices typically perform only simple form filling based on static templates and rule-based matching. Such systems generally treat user-provided project descriptions as unstructured text and rely on manual interpretation by human operators to identify relevant support programs. As a result, the utilization of computing resources for language understanding and decision making remains limited, and the throughput and consistency of the overall pipeline are constrained by human bottlenecks rather than by the capabilities of the underlying information processing hardware.

Furthermore, even when natural language processing techniques are employed, conventional systems often use fixed classification rules or narrow domain models that do not fully exploit generative models capable of dynamically composing application text. These systems typically do not construct explicit machine-readable instruction sentences for generative models, and therefore cannot flexibly adapt the generation process to the current project context, extracted features, or changing program conditions. This results in suboptimal use of processing units, as the generative models are invoked in an ad hoc fashion without structured prompts tailored to the computing task.

In addition, most existing platforms ignore or underutilize user emotion as an input signal to drive system behavior. Emotion-related information, when considered at all, is usually displayed to human operators but is not used as a computational parameter in selecting support programs, generating documents, or adjusting language style. Consequently, the computing pipeline disregards a valuable dimension of input data that could be used to condition processing flows and optimize results, leading to less efficient and less adaptive use of memory, processor cycles, and external model calls.

Moreover, conventional systems do not integrate downstream financial transaction information into the same computational loop that handles project analysis and document generation. Funding disbursement and management are commonly handled by separate financial tools that are disconnected from the core application-processing engine. This fragmentation prevents the processor from maintaining a unified, machine-readable management state for support funds, and hinders the implementation of automated, closed-loop optimization of application strategies and document content based on historical funding outcomes.

Therefore, there is a need for an improved computer-implemented system that: (i) receives and stores user-provided activity information and emotion information as structured data; (ii) performs natural language processing to extract classification and feature information; (iii) uses such information to compute optimal support program selection; (iv) programmatically constructs and refines prompt sentences as machine instructions to a generative model for generating and adjusting application documents; (v) incorporates emotion-derived signals into the generation and refinement of those documents; and (vi) integrates transaction information relating to received support funds into a unified management data structure. By addressing these needs, the system can more fully utilize modern computing architectures, increase automation, reduce manual intervention, and improve the technical efficiency and adaptability of the entire subsidy or funding application process.

The specific processing by the specific processing unit 290 of the data processing device 12 in Application Example 2 is realized by the following means.

The present invention provides a server comprising a processor and a storage unit, the processor being configured to receive, from a user via a user interface, activity information relating to an activity and emotion information relating to an emotional state of the user, and to store the activity information and the emotion information as structured information in the storage unit; to execute, by invoking natural language processing instructions, analysis on the activity information stored in the storage unit to extract classification information and feature information that are stored in association with the activity; to search, based on the classification information and the feature information, support program information stored in the storage unit so as to extract one or more candidate support programs, and to select an optimal support program from the one or more candidate support programs by performing evaluation computation using the processor; to construct, based on the activity information, the classification information, and condition information of the optimal support program, a prompt sentence as a generation instruction for a generative information processing model, and to input the prompt sentence to the generative information processing model via a model interface so as to cause the generative information processing model to generate a draft of an application document; to create, based on the generated draft of the application document and the activity information, an application document in a predetermined format, and to output the application document in a format that is transmittable to an external providing entity; to estimate the emotional state of the user based on the emotion information and the draft of the application document, to generate emotion information representing the emotional state, and to modify content or expression conditions of the prompt sentence according to the emotion information and re-input the modified prompt sentence to the generative information processing model so as to adjust a wording style or a structure of the draft of the application document; and to acquire, via a payment interface represented by interface information stored in the storage unit, transaction information relating to support funds received from the external providing entity, to update management information of the support funds based on the transaction information in the storage unit, and to output the management information to the user interface. This enables the computing system to dynamically integrate natural language understanding, optimal program selection, emotion-conditioned prompt construction, generative document synthesis, and financial transaction management within a unified processing pipeline, thereby improving utilization of processing resources, reducing manual intervention, enhancing adaptability of generated documents to user state, and increasing overall efficiency and reliability of computer-implemented funding application processing.
The term “processor” refers to a hardware information processing unit, such as a central processing unit, a graphics processing unit, or any other computing circuitry, that executes instructions to perform data processing, control, and computation tasks in the system.
The term “storage unit” refers to a hardware memory device, such as a semiconductor memory, a magnetic storage device, or an optical storage device, that stores programs, structured information, model data, interface information, and management information used by the processor.
The term “user interface” refers to a hardware and software interaction mechanism, including input and output components such as a display, a touch panel, a keyboard, a pointing device, a microphone, or a network client, that enables a user to provide information to the system and to receive information from the system.
The term “activity information” refers to information describing a planned or ongoing project, activity, or operation for which support or funding is sought, including at least a purpose, a scope, a schedule, a budget, and other descriptive data.
The term “emotion information” refers to information representing a current or recent emotional state of the user, such as stress, anxiety, confidence, or satisfaction, the information being provided explicitly by the user or derived from user input.
The term “structured information” refers to data that has been organized into a predefined format, such as records, fields, key-value pairs, or relational tuples, so that the processor can systematically access, analyze, and update the data.
The term “natural language processing” refers to a computational procedure executed by the processor to analyze text expressed in a human language, including operations such as tokenization, part-of-speech tagging, parsing, and entity extraction, in order to obtain classification information and feature information.
The term “classification information” refers to data indicating one or more categories or types assigned to the activity, such as a technical domain, a policy domain, or a funding domain, the data being derived from the activity information by the natural language processing.
The term “feature information” refers to extracted attributes or characteristics of the activity, including keywords, numerical values, locations, time periods, or other elements that describe the activity in a machine-readable manner.
The term “support program information” refers to information stored in the storage unit that describes available support or funding programs, including at least eligibility conditions, application requirements, financial limits, and other program-related parameters.
The term “candidate support programs” refers to one or more support or funding programs that are retrieved from the support program information based on the classification information and the feature information and that are considered as potential matches for the activity.
The term “evaluation computation” refers to a processing operation performed by the processor that calculates scores, rankings, or suitability measures for candidate support programs based on the classification information, the feature information, and the program conditions, in order to select an optimal support program.
The term “optimal support program” refers to a support or funding program selected by the processor as being most suitable for the activity among the candidate support programs, based on the evaluation computation.
The term “condition information” refers to information defining requirements, constraints, or parameters associated with a support or funding program, including at least eligibility criteria, documentation requirements, and assessment items used for application evaluation.
The term “prompt sentence” refers to a machine-readable instruction sentence or collection of sentences constructed by the processor, which specifies a generation task, context, and constraints for a generative information processing model.
The term “generative information processing model” refers to a trained computational model, such as a generative AI model or a language model, that receives a prompt sentence as input and outputs generated content including at least part of a draft of an application document.
The term “draft of an application document” refers to preliminary text or content generated by the generative information processing model based on the prompt sentence, the draft being subject to further editing, adjustment, or formatting to produce a finalized application document.
The term “application document” refers to a structured document, created in a predetermined format based on the draft of an application document and the activity information, that is intended for submission to an external providing entity as part of a support or funding application.
The term “predetermined format” refers to a document layout or schema defined in advance, including section structure, required fields, and presentation style, that conforms to requirements of the external providing entity or a standardized application template.
The term “external providing entity” refers to an external organization, such as a funding body, an administrative body, or another institution, that offers support programs and receives and evaluates application documents.
The term “emotional state” refers to a state of mind or affective condition of the user, such as anxious, stressed, calm, or confident, as estimated by the processor from emotion information and optionally from content of the draft of an application document.
The term “emotion information representing the emotional state” refers to data generated by the processor that encodes the emotional state of the user in a numerical or categorical form suitable for computational use in subsequent processing.
The term “expression conditions” refers to parameters or constraints used to control how text is generated by the generative information processing model, including at least tone, politeness, level of detail, and structural emphasis of the generated content.
The term “wording style” refers to stylistic characteristics of the text within the draft of an application document, including formality, length of sentences, complexity, and choice of expressions.
The term “structure of the draft of the application document” refers to the organization of sections, paragraphs, and logical flow of the draft of an application document, including ordering of topics and grouping of information.
The term “payment interface” refers to an interface, such as an application programming interface or messaging protocol, that enables the processor to obtain transaction information regarding support funds from an external financial service or external providing entity.
The term “transaction information” refers to data relating to financial operations involving support funds, including received amounts, dates, identifiers, and other attributes associated with disbursement or transfer events.
The term “support funds” refers to monetary resources granted or disbursed under a support or funding program to the beneficiary associated with the activity.
The term “management information of the support funds” refers to data stored in the storage unit that describes the state of support funds, including at least received amounts, usage records, balances, and allocation among activities.
The term “submission data” refers to an electronic data representation of the application document that is formatted and encoded for transmission to the external providing entity via a communication channel.

In one embodiment, a server cooperates with one or more terminals operated by a user to implement the claimed system. The server includes at least one processor and at least one storage unit. The processor is realized by a hardware information processing device such as a central processing unit and, in some embodiments, an additional accelerator such as a graphics processing unit. The storage unit is realized by a non-transitory computer-readable memory such as a semiconductor memory or a magnetic disk device. The server executes an application program written, for example, in a programming language such as Python running on an operating system such as a server-grade operating system. The terminal is realized by an information processing device such as a smartphone, a tablet, a personal computer, or a control computer embedded in an industrial apparatus, and includes at least a display and an input interface such as a touch panel or a pointing device.

The server stores, in the storage unit, program modules including at least: a user interface communication module, a data structuring module, a natural language processing module, a feature extraction module, a program selection module, a prompt generation module, a generative AI interface module, a document formatting module, an emotion estimation module, and a funds management module. The server further stores in the storage unit a plurality of data structures including: (i) a project data table storing activity information received from the terminal, (ii) an emotion data table storing emotion information associated with a user, (iii) a feature data table storing classification information and feature information extracted from the activity information, (iv) a support program table storing support program information such as eligibility conditions and evaluation criteria, and (v) a funds ledger table storing transaction information and management information of support funds.

The terminal presents a graphical user interface defined by the server. The terminal displays input fields for activity information such as project title, purpose, technical domain, schedule, estimated budget, and expected effect. The terminal further displays one or more input elements for emotion information such as a selectable scale (for example, “anxious”, “neutral”, “confident”) and a free-text field in which the user can describe concerns or feelings in natural language. The terminal transmits, via a communication network, the user input to the server using a structured protocol such as a request with text payload. The server receives the input and converts the input into structured information in which each item is stored as a field value associated with a unique project identifier.

The server uses the natural language processing module to process textual portions of the activity information. In one embodiment, the server loads a language model provided by a natural language processing library running on the processor. The server performs tokenization, sentence segmentation, and part-of-speech tagging to decompose the text into tokens with syntactic labels. The server then performs named entity recognition and pattern matching to identify entities such as technical domains (for example, energy, environment, transportation), quantitative values (for example, capacity, budget amount, time period), and geographical references. The server writes the identified entities and their attributes into the feature data table as feature information associated with the project identifier.

The server performs a classification procedure in which the processor computes a vector representation of the activity information. In one embodiment, the server maps each token or entity to an embedding vector of fixed dimension using an embedding matrix stored in the storage unit, and aggregates the embedding vectors using an operation such as weighted averaging or sequence encoding by a recurrent or attention-based neural network. The server inputs the aggregated vector into a trained classifier realized, for example, by a feed-forward neural network having multiple layers, in which each layer performs an affine transformation followed by a non-linear activation. The classifier outputs probabilities for a plurality of categories representing funding domains such as environmental protection, energy efficiency, regional revitalization, or recycling. The server selects one or more categories with highest probabilities and stores these categories as classification information in the feature data table.

The server uses the classification information and the feature information as query parameters to search the support program table. The support program table stores, for each support program, fields describing applicable domains, region restrictions, minimum and maximum budget thresholds, and evaluation criteria expressed as numerical weights for features such as expected impact, innovation, and scalability. The processor executes a search algorithm in which the server filters support programs by domain and region, then computes for each candidate a suitability score defined as a weighted sum or other function of the similarity between project features and program criteria. The similarity computation may use distance measures between the project's feature vector and each program's reference vector stored in the table. The support program having the highest suitability score is selected as an optimal support program and recorded in association with the project identifier.

The server constructs a prompt sentence suitable for a generative AI model by combining structured information with predetermined templates. The prompt generation module retrieves, from the storage unit, the activity information, the classification information, the feature information, and condition information of the optimal support program. The processor then inserts these pieces into a template that describes the desired output sections and tone. In one embodiment, the server generates a prompt sentence such as:
“You are an assistant for preparing funding application documents. The user plans the following project: [project description]. The project domain is [domain category], and the estimated budget is [budget amount]. The following support program has been selected: [program name and conditions]. Based on this information, draft a complete application document including sections: project overview, background and objectives, implementation plan, budget breakdown, and expected effects. Use a clear and professional tone and ensure that each section addresses the evaluation criteria defined in the program conditions.”

In another embodiment, when emotion information indicates that the user is anxious, the server includes explicit instructions in the prompt sentence:
“The user feels anxious about the application process. Write the application document in a supportive and easy-to-understand style while maintaining all technical details required by the program conditions.”

The generative AI interface module on the server transmits the constructed prompt sentence to a generative AI model executed on the same server or on a remote computation resource accessible via a network. The generative AI model is, for example, a trained neural network language model comprising multiple transformer layers, where each layer includes self-attention mechanisms and feed-forward sub-layers with residual connections and normalization. The model parameters, including weight matrices and bias terms, are stored either locally or in a remote model serving environment.

The server uses a training method in which such a neural network has been pre-trained by minimizing a prediction error function over large corpora of text. The error function is, for example, a cross-entropy loss between predicted probability distributions over tokens and actual observed tokens. The model parameters are updated via gradient-based optimization such as stochastic gradient descent or an adaptive variant. In some embodiments, the server further fine-tunes the generative AI model on a domain-specific corpus comprising past application documents and evaluation results, by continuing the optimization process with a lower learning rate and adding regularization to prevent over-fitting. The server may store configuration parameters such as number of layers, hidden dimensions, attention heads, learning rate, and batch size in a model configuration file in the storage unit.

The server uses the generative AI model in an inference mode. The generative AI model receives the prompt sentence as a token sequence and outputs a probability distribution over possible next tokens at each position. The server controls the generation procedure by specifying decoding parameters such as maximum length, temperature, or top-k sampling. The server obtains the generated token sequence representing a draft of an application document and converts the sequence back into text. The server stores the generated draft in the storage unit as part of the project data.

The server formats the draft into an application document in a predetermined format by invoking the document formatting module. The document formatting module retrieves a template corresponding to the selected support program. The template defines section headings, fixed text parts, and placeholders for generated content and structured fields such as organization name, contact information, and identifiers. The processor inserts the generated text into the placeholders, applies layout rules, and generates a document file in a format such as a word processing file or a portable document. The server stores a pointer to this file in the project data and makes the file available for retrieval by the terminal.

The terminal receives the formatted application document or the sectioned draft content from the server and displays the content to the user via the user interface. The terminal allows the user to edit text within each section, to attach additional information, and to correct any errors. When the user edits content, the terminal transmits the edited portions back to the server. The server merges the user edits into the stored draft and updates the document file. In some embodiments, the server uses the edited content as additional training or adaptation data for the generative AI model by recording patterns of corrections that systematically improve clarity or compliance with program rules.

The server uses the emotion estimation module to compute an emotional state of the user. The module combines the explicit emotion information received from the terminal with derived features such as sentiment values extracted from the user's free-text comments. The server may use an auxiliary classifier realized by another neural network that takes as input an embedding of the user comments and outputs a probability distribution over emotion categories. The classifier is trained by minimizing a cross-entropy loss between predicted and labeled emotion categories using a dataset of user statements with human-annotated emotions. The server stores the resulting emotion probabilities as emotion information representing the emotional state.

The server uses the emotion information to modify the prompt sentence and refine the draft. For example, when the emotion information indicates high anxiety, the server lowers a tone parameter and adds explicit instruction phrases such as “avoid overly technical phrases” or “include clear explanations of why the project fits the criteria” to the prompt sentence. When the emotion information indicates high confidence, the server adjusts the prompt sentence to request more concise and formal text. The server re-invokes the generative AI model with the modified prompt sentence, and receives a refined draft that is adjusted in wording style and structure. The server then determines, under program logic, which sections of the refined draft to merge with the previous version, so that factual content provided by the user is preserved while style and organization are optimized.

The server also uses the funds management module to process transaction information. The server connects to an external payment system via a payment interface defined by an application programming interface. The server periodically queries the payment system or receives notifications containing transaction information such as transaction identifiers, amounts, and timestamps. The processor associates each transaction with a project and a support program using stored reference identifiers. The server updates the funds ledger table by adding a record for each transaction and recalculating balances, allocations, and usage rates. The server can compute summary values such as total received funds and remaining funds by executing aggregation queries on the ledger table. The server sends these values to the terminal, where they are displayed to the user as part of a management screen.

By structuring data into explicit tables and feature vectors and by separating functional modules as described above, the server improves internal data management and reduces the risk of inconsistent state. The classification and selection processes are not simple rule-based mappings but use numeric feature vectors and trained neural networks to capture complex correlations between project characteristics and program suitability. The generation and refinement of prompt sentences, together with emotion-conditioned style instructions, allow the system to control the generative AI model in a way that is not achievable by human manual drafting alone, leading to text outputs that better match both program conditions and user state.

From a technical perspective, the server reduces processing time and communication overhead by performing feature extraction and classification close to where data is stored, and by transmitting only summarized results rather than raw text in some modes. The use of vectorized representations and batched computation on the processor or accelerator permits efficient use of hardware instruction sets and parallel execution units. The server minimizes repeated accesses to external model hosts by caching prompt templates and by embedding configuration parameters locally. These configurations contribute to reduced response latency in generating application documents, as well as improved throughput when many users access the system concurrently.

In addition, the system improves accuracy of program selection and document preparation by learning from feedback. When the external providing entity accepts or rejects applications, the server records the outcome in association with project features, selected programs, and document characteristics. The server can use this historical data to retrain or fine-tune the classification and scoring models, by adjusting weights to emphasize features correlated with success. The server may implement a loss function that penalizes misclassification of successful and unsuccessful cases differently, and may adopt data augmentation techniques such as synonym replacement or paraphrasing of project descriptions to make the models more robust. Consequently, the server's ability to predict suitable programs and to shape documents that conform to evaluation criteria improves over time, which leads directly to technical effects such as reduced error rate in program selection and more stable performance of the generative AI model in this particular application domain.

The described embodiment can be varied in multiple ways. In one alternative, the server executes the generative AI model locally using a reduced-size architecture optimized for execution on an edge computing device, thereby reducing network dependence. In another alternative, the terminal performs a subset of the natural language processing steps, such as tokenization and preliminary entity detection, to offload computation from the server and reduce server load. In still another alternative, the server uses different neural network architectures for the classification model, such as convolutional networks for text classification or hybrid models combining recurrent and attention-based layers, depending on hardware capabilities and target accuracy.

In all of these embodiments, the server, the terminal, and the user cooperate so that the claimed system does not merely automate a known human workflow, but instead implements a specific arrangement of data structures, neural network models, prompt sentences, and control logic that improves the way a computer processes, generates, and manages application-related information. The tight coupling of feature-based selection, emotion-conditioned generative processing, and financial transaction integration yields measurable technical effects including increased processing speed, improved accuracy of program selection, decreased rate of formatting and content errors, and more efficient usage of memory and communication bandwidth within the computer system.

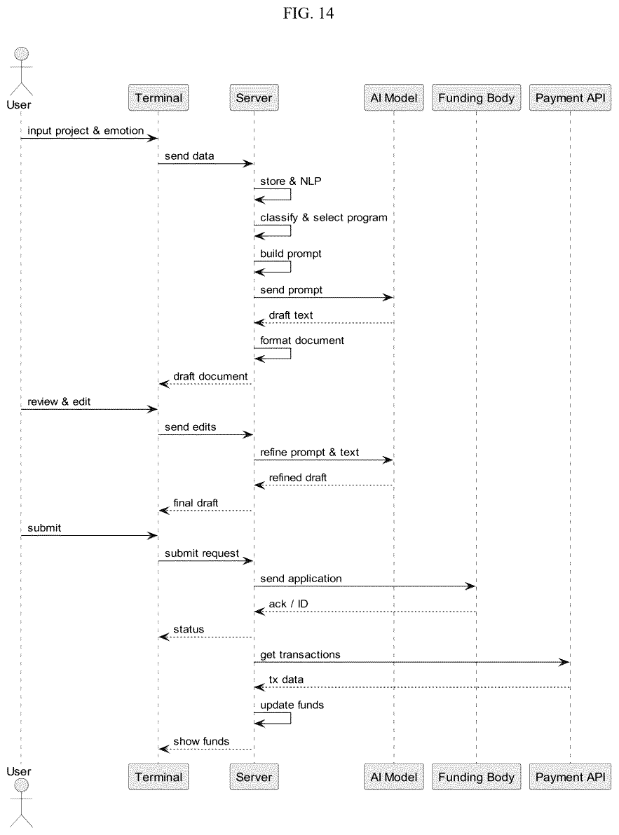

The following describes the processing flow using FIG. 14.

### Step 1:

User initializes a new project session on the terminal.

User operates the terminal to open an application screen and selects an option to create a new project. User inputs activity information, including at least a project title, a textual description of the activity, an estimated budget, a schedule, and an expected effect, into text fields. User further inputs emotion information, such as selecting a current emotional state (for example, “anxious” or “confident”) and optionally entering free-text comments about concerns.

Terminal receives the user input as raw text and numerical values (input) and performs local validation, such as checking that required fields are not empty and that the budget field contains a numeric value. Terminal converts the validated input into a structured data object, for example a set of key-value pairs, and transmits this structured object as a request to the server (output).

### Step 2:

### Server Receives and Stores Structured User Input.

Server accepts the request from the terminal containing the activity information and emotion information (input). Server parses the structured data into internal variables and assigns a unique project identifier to the new project. Server performs a data processing operation in which each input field is mapped to a column of a project data table or an emotion data table in a storage unit. Server writes the activity information and the emotion information as records indexed by the project identifier. Server then outputs an acknowledgment to the terminal including the project identifier (output).

### Step 3:

Server executes natural language preprocessing on the activity description.

Server retrieves the textual portion of the activity information corresponding to the project identifier from the storage unit (input). Server uses a natural language processing library to perform tokenization, sentence segmentation, and part-of-speech tagging on the text. Server treats each sentence as a sequence of tokens and, for each token, computes syntactic labels. This data processing converts unstructured text into a sequence of annotated tokens. Server outputs a token list with annotations as intermediate data for further analysis (output).

### Step 4:

Server performs entity extraction and feature construction.

Server takes the annotated token list (input) and applies named entity recognition and pattern-matching rules to detect entities such as technical domains, budget values, time periods, geographic locations, and equipment types. Server executes data operations that normalize these entities, such as converting currency expressions into a standard numeric format and mapping domain terms to predefined domain codes. Server constructs a feature vector for the project by combining numeric attributes (for example, normalized budget) and categorical attributes (for example, domain codes). Server writes feature information and classification candidate hints into a feature data table and outputs the feature vector and associated metadata as structured feature information (output).

### Step 5:

Server classifies the activity using a trained neural classifier.

Server receives the feature vector and, optionally, a sequence representation of the project text (input). Server loads a trained classifier implemented as a neural network with multiple layers, where each layer performs a matrix multiplication followed by a non-linear activation. Server computes a category probability distribution by applying the classifier to the feature vector. This computation includes forward propagation across layers, where each layer generates intermediate activations that are used as input to the next layer. Server selects one or more categories, such as “environmental protection” or “energy efficiency”, with maximum probabilities. Server stores these categories as classification information in the storage unit and outputs the classification information and category scores (output).

### Step 6:

Server searches support program information and selects an optimal support program.

Server takes as input the classification information, the feature information, and support program records stored in a support program table (input). Server filters the support program records by domain, region, and budget range by executing queries over the table. For each remaining candidate support program, server computes a suitability score by applying an evaluation function that calculates a weighted sum or similarity measure between the project's feature vector and each program's reference vector. This data computation produces a numeric score for each candidate. Server compares the scores and selects the candidate with the highest score as an optimal support program. Server stores the selected program identifier and condition information in association with the project and outputs the optimal support program and its relevant conditions (output).

### Step 7:

Server generates a prompt sentence for a generative AI model.

Server accepts as input the activity information, the classification information, the feature information, the optimal support program's condition information, and, optionally, the user's emotion information (input). Server constructs a prompt sentence by inserting these pieces into one or more prompt templates stored in the storage unit. Server performs string concatenation and token insertion operations so that the resulting prompt sentence explicitly specifies the project context, the support program requirements, the required sections of the application document, and any style constraints derived from the emotion information. For example, server may generate a prompt sentence such as:
“You are an assistant for preparing funding application documents. The user plans the following project: [project description]. The project domain is [domain category], and the estimated budget is [budget amount]. The following support program has been selected: [program conditions]. Based on this information, draft a complete application document including sections: project overview, background and objectives, implementation plan, budget breakdown, and expected effects. Use a clear and professional tone.”

Server outputs the constructed prompt sentence as text ready for submission to the generative AI model (output).

### Step 8:

Server calls the generative AI model to produce a draft application document.

Server sends the prompt sentence to the generative AI model via a model interface (input). The generative AI model is realized by a multi-layer neural network, for example a transformer-based language model, that has been trained by minimizing a prediction error over large text corpora. Server receives, for each time step in the decoding process, a probability distribution over possible next tokens, and performs a decoding operation such as greedy selection or top-k sampling. This computation iteratively appends tokens until a termination condition is met. The result is a generated token sequence representing a draft of an application document. Server converts the token sequence into text strings corresponding to document sections and stores them in the storage unit. Server outputs the generated draft text associated with section identifiers (output).

### Step 9:

Server formats the generated text into a structured application document.

Server takes as input the generated draft text, the activity information, and a document template corresponding to the optimal support program (input). Server uses a document formatting module to inject the generated text into predefined placeholders in the template, and to fill static fields such as applicant name and project identifier from the stored activity information. Server performs layout operations including insertion of section headings, numbering, and page breaks, and it generates a file in a predetermined format such as a word processing file or a portable document. Server stores the generated file in the storage unit and outputs a file reference and, optionally, sectioned text suitable for display on the terminal (output).

### Step 10:

Terminal displays the draft document and receives user corrections.

Terminal receives the file reference or sectioned text for the draft application document from the server (input). Terminal renders the text on the display, dividing the content into editable sections such as “Project Overview” and “Implementation Plan”. Terminal provides input controls, such as text boxes and buttons, through which the user can edit the content. User reads each section and edits sentences to add missing technical details, correct values, or adjust wording. When user finishes editing, terminal gathers the modified sections and constructs a correction data object. Terminal outputs the correction data object to the server (output).

### Step 11:

Server merges user corrections and optionally refines the draft using a modified prompt sentence.

Server receives the correction data object containing edited sections (input). Server merges the edited text into the stored draft by overwriting the corresponding sections and maintains a version history of changes. In some configurations, server builds a refinement prompt sentence that references both the original draft and the corrected sections, optionally incorporating emotion information. For example, server may generate the following prompt sentence:
“Refine the following subsidy application text, keeping all factual details but improving clarity and structure. The user's emotional state is [emotion state]. Original text: [combined corrected sections].”

Server sends this refinement prompt to the generative AI model and receives a refined version of the text. Server then performs a comparison operation to decide whether to adopt the refined version as a replacement or to selectively merge stylistic improvements. Server outputs the finalized version of the application text and updates the stored application document file (output).

### Step 12:

Server estimates the user's emotional state and adjusts prompt sentences accordingly.

Server uses the emotion information originally received from the terminal and, optionally, textual comments or interaction patterns as input (input). Server feeds this information into an emotion estimation model implemented, for example, as a classifier neural network that outputs probabilities for several emotion categories. Server computes an estimated emotional state by selecting the category with the highest probability or by interpreting the probability vector. Server generates updated emotion information representing the emotional state. Server then modifies future prompt sentences by adding style constraints, such as “use a reassuring tone” or “make the explanation concise and formal,” based on the emotion information. This processing results in adjusted prompt sentences that directly influence the behavior of the generative AI model. Server outputs the updated emotion information and modified prompt templates for use in subsequent invocations (output).

### Step 13:

User confirms the final application document on the terminal.

Terminal receives the finalized application text or document file from the server (input). Terminal displays the application document to the user in a read-only or minimally editable form, indicating that this version is intended for submission. User reviews all sections, verifies that factual details are correct, and ensures that the document meets the required format. When user is satisfied, user operates a “Submit” control on the terminal. Terminal constructs a submission request referencing the project identifier and the final document version and outputs this request to the server (output).

### Step 14:

Server submits the application document to an external providing entity.

Server receives the submission request from the terminal (input). Server retrieves the final application document file and associated metadata, such as applicant information and selected support program identifier, from the storage unit. Server then prepares a submission payload in accordance with communication specifications of the external providing entity, performing data transformations such as encoding the document file, adding necessary fields, and formatting the payload as a structured message. Server transmits the payload through a communication interface to the external providing entity. Server receives a response containing an acknowledgment or an application identifier and stores this information as part of the project data. Server outputs a submission status and the external identifier to the terminal (output).

### Step 15:

Server manages support funds using transaction information from an external payment system.

Server monitors a payment interface for notifications or queries the interface at intervals to obtain transaction information relating to support funds associated with submitted and approved projects (input). Server parses each transaction record to extract data fields such as amount, date, and transaction identifier, and matches these records to project identifiers and support programs stored in the system. Server updates a funds ledger table by inserting or modifying records and recalculates summary statistics, including total funds received and current balance. Server stores updated management information and computes derived indicators, such as utilization ratios, using arithmetic operations across ledger entries. Server outputs the updated management information to the terminal for display to the user (output).

### Step 16:

Terminal presents funding status and allows ongoing interaction based on system outputs.

Terminal receives the management information and submission status from the server (input). Terminal displays summary views, such as charts or tables, showing approved funds, received amounts, and remaining funds for each project. User can view details and may input further instructions, such as initiating new applications or requesting document revisions. Terminal collects any new input and transmits corresponding requests back to the server. Terminal outputs updated interaction data for use in further processing cycles (output).

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

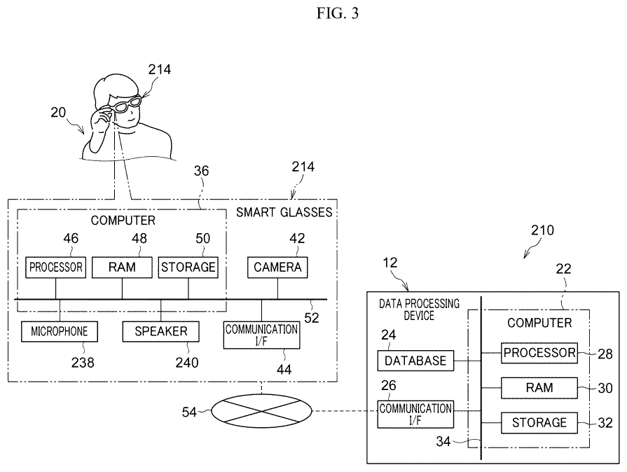

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

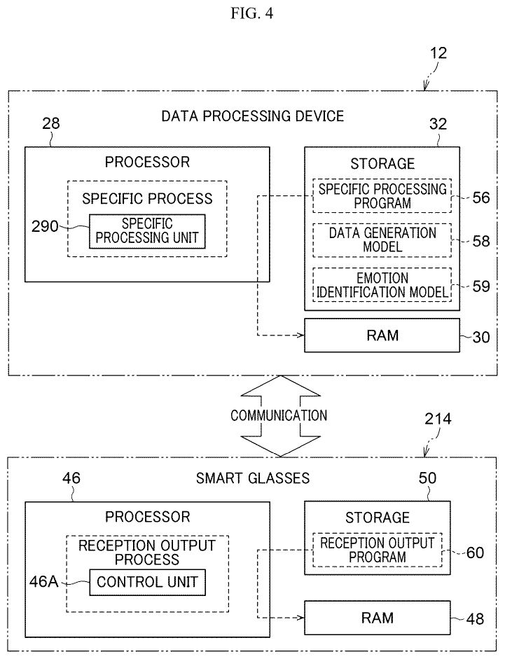

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

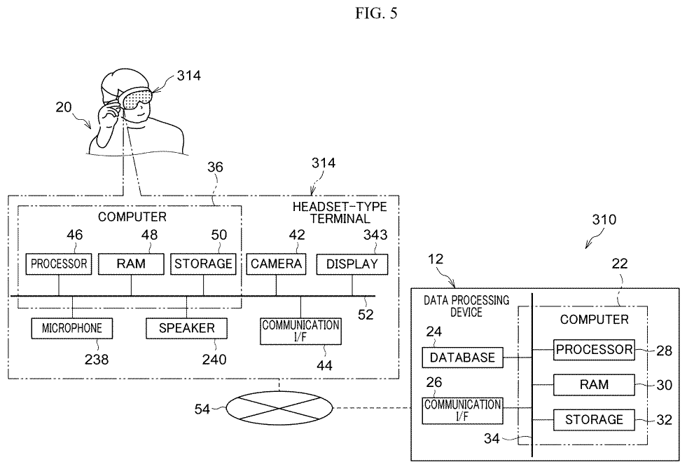

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

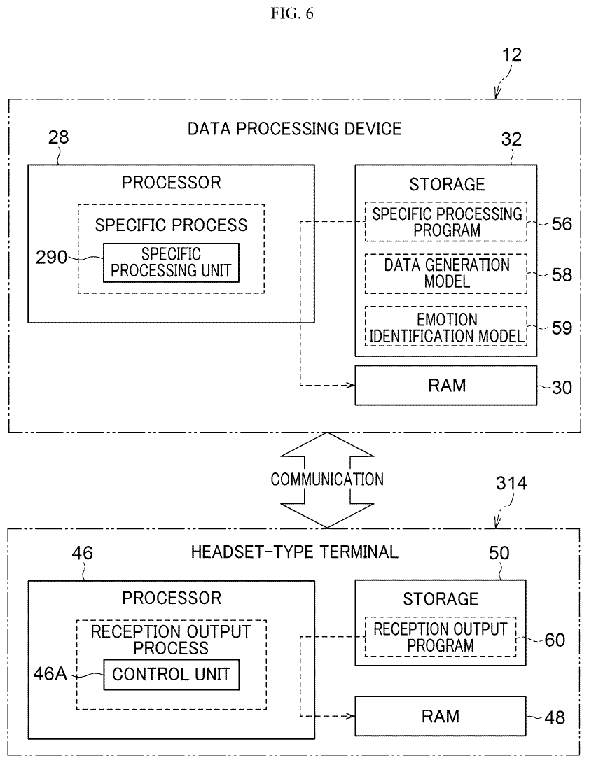

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

Fourth Exemplary Embodiment

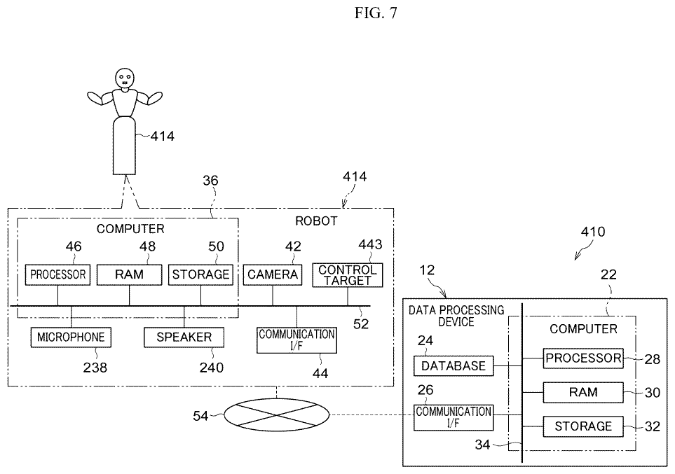

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

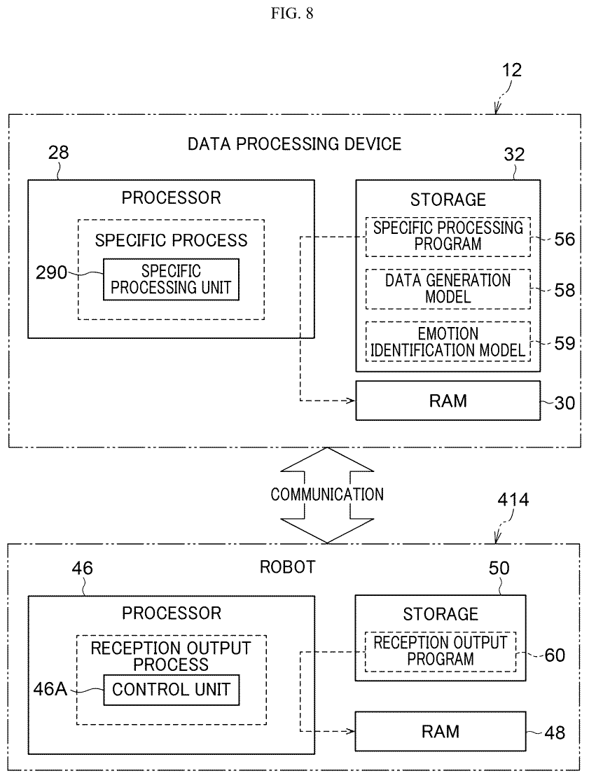

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

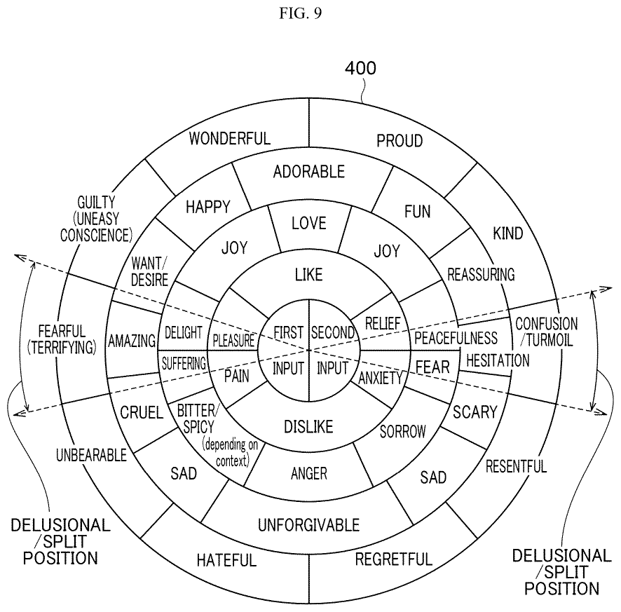

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

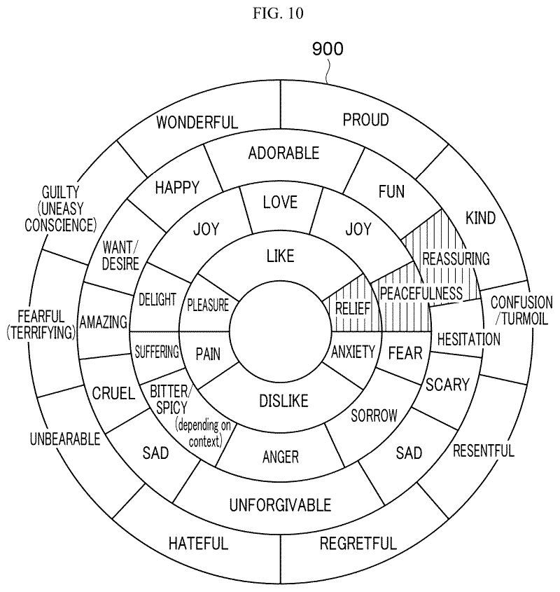

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive character information including activity content from a user terminal and store the character information in a storage device,
generate a prompt sentence for instructing a generative AI model to execute an analysis process by using the character information and attribute information related to the activity content as input, and extract structured information related to the activity content and feature information used for selection of a financial assistance scheme based on an analysis result acquired from the generative AI model,
execute a search process on a data storage device in which financial assistance scheme information is stored by using the structured information and the feature information, extract a plurality of financial assistance scheme candidates suitable for the activity content, calculate a suitability degree for each of the candidates, and select an optimal financial assistance scheme,
determine a correspondence relationship between placeholders corresponding to respective items of an application document and the structured information, based on document format information associated with the selected financial assistance scheme and the structured information, and generate application document data by automatically filling the placeholders according to the correspondence relationship,
generate a prompt sentence for using the generative AI model for creation, correction, or summarization of the application document data, and input the prompt sentence and the application document data to the generative AI model to complement or format content of the application document data,
convert the complemented or formatted application document data into a display data format and transmit the display data format to the user terminal via a communication unit, and
reflect correction content for the application document data, the correction content being received from the user terminal, in the application document data to generate final application document data, and transmit the final application document data to an external application reception apparatus.

### Supplementary 2

The system according to supplementary 1,
wherein the processor is configured to
generate a prompt sentence for inputting information related to a user emotion or operation history information on the user terminal to the generative AI model, and, based on an analysis result related to an emotional state acquired from the generative AI model, adjust expression content or explanation content included in the application document data to a writing style or a level of detail corresponding to the emotional state.

### Supplementary 3

The system according to supplementary 1,
wherein the processor is configured to generate a prompt sentence for causing the generative AI model to verify presence or absence of mandatory description items with respect to a creation process of the application document data or the final application document data, extract missing items or unclear items based on a verification result acquired from the generative AI model, and present the missing items or the unclear items on a user interface to prompt additional input.

### Application Example 1

### Supplementary 1

A system comprising a processor,
wherein the processor is configured to
receive user information from a user terminal via a communication network and store the user information in an information management area in a storage device,
preprocess the stored user information to generate standardized text data, generate an analysis prompt sentence for inputting the standardized text data as analysis input data to a generative AI model, and transmit the analysis prompt sentence and the standardized text data to the generative AI model,
obtain an analysis result from the generative AI model, extract characteristic information including at least a business classification, a target field, region information, and related expressions based on the analysis result, and store the characteristic information in association with the user information in the information management area,
execute a query process on a structured information storage area in which funding aid scheme information is stored, using the characteristic information as search conditions, acquire a plurality of funding aid candidate pieces of information, calculate a suitability index for each of the plurality of funding aid candidate pieces of information, rank the plurality of funding aid candidate pieces of information based on the suitability index, and select optimal funding aid information,
acquire template information defining a structure and items of an application document based on the optimal funding aid information and the user information, and generate application document draft data by associating and placing the user information in items of the template information,
generate a description-generation prompt sentence for an application document using structured data including the optimal funding aid information and the characteristic information as input conditions for generating descriptive text in the application document draft data, input the description-generation prompt sentence and the structured data into the generative AI model, obtain natural-language text from the generative AI model, and
automatically place the natural-language text in explanation items of the application document draft data,
transmit the application document draft data including the explanation items to the user terminal via a user interface, receive additional input or correction input from a user, update the application document draft data based on the additional input or the correction input, and
store updated application document data as final application document data in the information management area, and
generate an electronic document file in a submission format corresponding to an external organization from the final application document data, and transmit the electronic document file and related metadata to an external information processing device to complete an application process.

### Supplementary 2

The system according to supplementary 1,
wherein the processor is configured to
generate an emotion-analysis prompt sentence for estimating an emotional state with respect to text data acquired as the user information, input the emotion-analysis prompt sentence and the text data into the generative AI model to obtain emotional state information, and adjust at least one of style, politeness level, and emphasis items of the description-generation prompt sentence for the application document based on the emotional state information, thereby adjusting descriptive content of the application document.

### Supplementary 3

The system according to supplementary 1,
wherein the processor is configured to
cause the user interface to display, as status information, content of the optimal funding aid information and a creation status of the final application document data, execute generation of the electronic document file and transmission of the electronic document file to the external information processing device only when a submission instruction is received from the user based on the status information, and record a transmission result as history information in the information management area.

### Example 2

### Supplementary 1

A system comprising a processor,
wherein the processor is configured to
receive, via a terminal, activity information expressed in natural language from a user as processing-target information, and store the activity information as structured data in a storage device,
generate a prompt sentence including the stored activity information, cause a generative AI model to execute natural language analysis processing by using the prompt sentence, and obtain classification information and keyword information corresponding to the activity information,
perform a search process on a database in which funding program information is stored, based on the classification information and the keyword information, extract candidate funding programs suitable for the activity, and execute relevance evaluation processing on the candidates to select an optimal funding program,
generate, based on application requirement information of the selected funding program and the activity information, structured data for respective entry items of an application document, format a template based on a document description language by using the structured data, and automatically generate an electronic document having a predetermined format,
generate display data corresponding to the automatically generated electronic document, transmit the display data to the terminal, and enable the user to confirm and edit content of the electronic document via the terminal, and
update, based on edit content received from the terminal, the structured data and the electronic document, store an updated electronic document as a final document for application in the storage device, and complete an application process to the funding program by transmission or output of the final document.

### Supplementary 2

The system according to supplementary 1,
wherein the processor is configured to include, in the prompt sentence transmitted to the generative AI model, constraint information indicating search conditions of the funding program and structural requirements of the application document, obtain, from the generative AI model, classification information and keyword information optimized for the activity information, and use the classification information and the keyword information for both the search process and automatic generation processing of the application document.

### Supplementary 3

The system according to supplementary 1,
wherein the processor is configured to
store, in the storage device as structured data, correction content input from the user via the terminal in a stepwise manner, and automatically regenerate a plurality of electronic documents with version management by reforming again the template based on the document description language using the stored structured data, and use a predetermined version among the plurality of electronic documents as a final application document to the funding program.

### Application Example 2

### Supplementary 1

A system comprising a processor and a storage unit,
wherein the processor is configured to
receive, from a user via a user interface, activity information relating to an activity and emotion information relating to an emotional state of the user, and store the activity information and the emotion information as structured information in the storage unit,
execute natural language processing on the activity information stored in the storage unit to extract classification information and feature information,
search, based on the classification information and the feature information, support program information stored in the storage unit to extract one or more candidate support programs, and
select an optimal support program from the one or more candidate support programs by performing evaluation computation,
construct, based on the activity information, the classification information, and condition information of the optimal support program, a prompt sentence as a generation instruction for a generative AI model, and input the prompt sentence to the generative AI model to cause the generative AI model to generate a draft of an application document,
create, based on the generated draft of the application document and the activity information, an application document in a predetermined format, and output the application document in a format that is transmittable to an external providing entity, and
acquire, via a payment interface stored as interface information in the storage unit, transaction information relating to support funds received from the external providing entity, update management information of the support funds based on the transaction information, and output the management information to the user interface.

### Supplementary 2

The system according to supplementary 1,
wherein the processor is configured to
estimate the emotional state of the user based on the emotion information received from the user and on the draft of the application document output by the generative AI model, generate emotion information representing the emotional state, and modify content or expression conditions of the prompt sentence according to the emotion information, and re-input the modified prompt sentence to the generative AI model to adjust a wording style or a structure of the draft of the application document.

### Supplementary 3

The system according to supplementary 1,
wherein the processor is configured to
cause the user interface to display at least one of the draft of the application document and an adjusted application document, receive correction input from the user via the user interface,
reflect the correction input in the application document, and output the application document in which the correction input has been reflected as submission data to the external providing entity.

What is claimed is:

1. A system comprising:
circuitry configured to:
receive, via a communication interface coupled to a packet-switched network, input text data comprising activity description content from a terminal device, and store the input text data in a storage device;
generate a first prompt sentence that instructs a generative model to analyze the input text data together with attribute information associated with the activity description content, transmit the first prompt sentence to the generative model via the communication interface, and extract structured records and feature vectors from an analysis result returned by the generative model;
execute a search process on a program record data store using the structured records and the feature vectors to retrieve program record candidates, compute a match score for each program record candidate based on the structured records and the feature vectors, and select an optimal program record based on the match scores;
determine a correspondence between placeholder fields in a document template associated with the selected program record and the structured records, and generate output document data by automatically inserting content from the structured records into the placeholder fields according to the correspondence;
generate a second prompt sentence incorporating the output document data, transmit the second prompt sentence to the generative model via the communication interface, receive formatted document data from the generative model, and transmit the formatted document data to the terminal device; and
receive correction data for the formatted document data from the terminal device, apply the correction data to the formatted document data to generate final document data, and transmit the final document data to an external receiving apparatus via the communication interface.

2. The system according to claim 1, wherein extracting the structured records from the analysis result comprises parsing a structured output field of the analysis result to identify at least a category label, a keyword list, and a constraint condition set associated with the activity description content.

3. The system according to claim 2, wherein the feature vectors are extracted from the analysis result as numerical representations of the keyword list, and wherein executing the search process comprises computing a similarity score between each feature vector and a corresponding index vector stored in the program record data store.

4. The system according to claim 3, wherein computing the match score comprises combining the similarity score with a constraint matching score derived by evaluating the constraint condition set against eligibility criteria stored in each program record candidate, and weighting the combined score by a relevance weight associated with each program record candidate.

5. The system according to claim 1, wherein generating the second prompt sentence comprises inserting the formatted document data into a prompt template together with a formatting instruction specifying at least one of a target length, a formality level, and a structural constraint for the formatted document data.

6. The system according to claim 5, wherein the circuitry is configured to receive, together with the correction data, a correction type indicator specifying one of a content correction type and a format correction type, and to generate a correction prompt sentence that incorporates the correction data and the correction type indicator, transmit the correction prompt sentence to the generative model, and replace a portion of the formatted document data with corrected content returned by the generative model.

7. The system according to claim 1, wherein the circuitry is configured to generate a third prompt sentence incorporating user state data received from the terminal device, transmit the third prompt sentence to the generative model, receive state analysis data from the generative model, and adjust at least one of a response verbosity level and a prompt complexity level based on the state analysis data.

8. The system according to claim 7, wherein the user state data comprises at least one of interaction frequency data, response latency data, and input length data collected from a sequence of prior interactions with the terminal device, and wherein the state analysis data comprises a state category label derived from the user state data.

9. The system according to claim 1, wherein the document template associated with the selected program record is retrieved from the storage device based on a template identifier stored in the selected program record, and wherein the placeholder fields are defined in the document template as tagged positions corresponding to respective structured record fields.

10. The system according to claim 9, wherein the circuitry is configured to detect, prior to transmitting the formatted document data, unresolved placeholder fields in the output document data that were not filled by the structured records, and to generate a completion prompt sentence requesting the generative model to generate content for the unresolved placeholder fields based on the input text data.

11. The system according to claim 1, wherein transmitting the final document data to the external receiving apparatus comprises packaging the final document data according to a transmission format specification stored in the selected program record, addressing the packaged data to a registered address of the external receiving apparatus, and transmitting the packaged data via the communication interface.

12. The system according to claim 11, wherein the circuitry is configured to receive a transmission acknowledgment from the external receiving apparatus, store the transmission acknowledgment in the storage device in association with the final document data, and transmit a status notification to the terminal device indicating a transmission result based on the transmission acknowledgment.

13. The system according to claim 1, wherein the circuitry is configured to store a history record in the storage device for each completed processing cycle, the history record comprising the input text data, the selected program record identifier, the final document data, and a completion timestamp, and to retrieve a prior history record in response to a retrieval request from the terminal device.

14. The system according to claim 13, wherein the circuitry is configured to generate, from the plurality of stored history records, a statistical summary of program record selections and match scores, and to incorporate the statistical summary into a subsequent first prompt sentence to bias the generative model analysis toward program records with historically high match scores.

15. The system according to claim 1, wherein the circuitry is configured to monitor the program record data store for updates by periodically transmitting a query to the program record data store and comparing a retrieved version identifier against a version identifier stored in the storage device, and to update cached program record data in the storage device when a version mismatch is detected.

16. The system according to claim 15, wherein when updated program record data is received from the program record data store, the circuitry is configured to recompute index vectors for the updated program records and replace corresponding index vectors stored in the storage device with the recomputed index vectors.

17. The system according to claim 1, wherein the attribute information associated with the activity description content is received from the terminal device together with the input text data, and comprises at least a category code, a scale indicator, and a time-period value associated with the activity described in the input text data.

18. A system comprising:
circuitry configured to:
receive, via a communication interface coupled to a packet-switched network, input text data comprising activity description content from a terminal device, and store the input text data in a storage device;
generate a first prompt sentence instructing a generative model to analyze the input text data and attribute information, transmit the first prompt sentence to the generative model via the communication interface, and extract structured records and feature vectors from an analysis result returned by the generative model;
compute a match score for each program record candidate retrieved from a program record data store using the structured records and the feature vectors, select an optimal program record, and generate output document data by inserting content from the structured records into placeholder fields of a document template associated with the selected program record; and
generate a second prompt sentence incorporating the output document data, transmit the second prompt sentence to the generative model via the communication interface, receive formatted document data from the generative model, and transmit the formatted document data to the terminal device.

19. The system according to claim 18, wherein the circuitry is configured to receive correction data for the formatted document data from the terminal device, apply the correction data to generate final document data, and transmit the final document data to an external receiving apparatus via the communication interface.

20. A method comprising:
receiving, via a communication interface coupled to a packet-switched network, input text data comprising activity description content from a terminal device, and storing the input text data in a storage device;
generating a first prompt sentence that instructs a generative model to analyze the input text data together with attribute information associated with the activity description content, transmitting the first prompt sentence to the generative model via the communication interface, and extracting structured records and feature vectors from an analysis result returned by the generative model;
executing a search process on a program record data store using the structured records and the feature vectors to retrieve program record candidates, computing a match score for each program record candidate based on the structured records and the feature vectors, and selecting an optimal program record based on the match scores;
determining a correspondence between placeholder fields in a document template associated with the selected program record and the structured records, and generating output document data by automatically inserting content from the structured records into the placeholder fields according to the correspondence;
generating a second prompt sentence incorporating the output document data, transmitting the second prompt sentence to the generative model via the communication interface, receiving formatted document data from the generative model, and transmitting the formatted document data to the terminal device; and
receiving correction data for the formatted document data from the terminal device, applying the correction data to the formatted document data to generate final document data, and transmitting the final document data to an external receiving apparatus via the communication interface.
